(19) United States
(12) Patent Application Publication
(10) Pub. No.: US 2026/0355689 A1
(43) Pub. Date: Nov. 12, 2026

(54) AN OXYGEN STORAGE COMPONENT-CONTAINING CATALYST FOR THE TREATMENT OF AN EXHAUST GAS STREAM CONTAINING ONE OR MORE OF FORMALDEHYDE, NITROGEN OXIDE (NO), AND HYDROCARBONS

(71) Applicant: BASF CORPORATION, Florham Park, NJ (US)

(72) Inventors: Shiang SUNG, Iselin, NJ (US); Jeffrey B. HOKE, Iselin, NJ (US)

(21) Appl. No.: 19/134,917

(22) PCT Filed: Dec. 4, 2023
(86) PCT No.: PCT/EP2023/084163

§ 371 Date: Jun. 2, 2025

(30) Foreign Application Priority Data
Dec. 2, 2022 (EP) 22211101.5

(51) Int. Cl. B01D 53/94; B01J 23/889; B01J 29/74; B01J 35/00; B01J 35/30; B01J 37/02; F01N 3/035; F01N 3/20; F01N 3/28

(52) U.S. Cl. CPC B01D 53/944; B01J 23/8892; B01J 29/7415; B01J 35/19; B01J 35/394; B01J 37/0244; F01N 3/035; F01N 3/2013; F01N 3/2033; F01N 3/2066; F01N 3/2803; B01D 2255/1021; B01D 2255/1023; B01D 2255/2065; B01D 2255/2073; B01D 2255/20761; B01D 2255/9025; B01D 2255/9032; B01D 2255/908; B01D 2255/912; B01D 2257/404; B01D 2257/702; B01D 2257/708; B01D 2258/012; F01N 2370/04; F01N 2510/063; F01N 2510/0684

(57) ABSTRACT

A catalyst for the treatment of an exhaust gas stream containing one or more of formalde-hyde, nitrogen oxide (NO), and hydrocarbons, the catalyst comprising a first washcoat layer comprising Mn and optionally Ce, wherein Mn and optional Ce are respectively supported on a metal oxide, a second washcoat layer comprising Mn supported on an oxygen storage component, wherein the oxygen storage component comprises ceria, and a substrate, wherein the substrate has an inlet end, and an outlet end, wherein the catalyst further comprises one or more platinum group metals comprising Pt, Pd, or Pt and Pd, wherein the one or more platinum group metals are at least in part contained in one or more of: (a) the first washcoat layer, (b) the second washcoat layer, and (c) an optional third washcoat layer, or (d) optional third and fourth washcoat layers.

### TECHNICAL FIELD

The present invention relates to an oxygen storage component-containing catalyst for the treatment of an exhaust gas stream containing one or more of formaldehyde, nitrogen oxide (NO), and hydrocarbons, an exhaust gas treatment system comprising said catalyst, a method for the treatment of an exhaust gas stream containing one or more of formaldehyde, nitrogen oxide (NO), and hydrocarbons using said catalyst, and use of said catalyst for the oxidation of one or more of formaldehyde, nitrogen oxide (NO), and hydrocarbons.

### INTRODUCTION

The present invention relates to a diesel oxidation catalyst (DOC) with enhanced oxidation function, in particular with enhanced oxidation function of one or more of formaldehyde (HCHO), nitrogen oxide, and hydrocarbons (including diesel fuel). It is known that formaldehyde is a toxic material that is coming under increasing regulation within indoor air spaces due to its release from various building materials used in the construction industry. Tighter regulations are also being implemented for formaldehyde emissions from the engine exhaust of passenger and delivery vehicles. Generally, manganese oxides (e.g., MnO₂) are known to be active for destroying formaldehyde under ambient conditions, but they do not have the required thermal stability to survive in a typical engine exhaust environment. In particular, phase transitions at high temperature (e.g., higher than 400 °C) can cause the structure of MnO₂ to collapse such that the surface area and pore volume are so low as to be catalytically ineffective. One way to improve the stability of the Mn oxide at high temperature (as well as other catalytically useful base metal oxides such as copper, ceria and iron) can be to support them on refractory oxide materials which themselves have high stability when exposed to high temperatures in the engine exhaust. Materials such as aluminum oxide (Al₂O₃) and zirconium oxide (ZrO₂) can be useful in this regard.

The key challenge for inclusion of Mn-containing base metal oxide (BMO) catalysts in technology for abatement of exhaust emissions from diesel vehicles can be seen in the intrinsically poor S resistance of Mn reflected in the high desulfation temperature of manganese sulfate. As described in the literature, significant desulfation of MnSO₄ does not occur at temperatures typical for filter regeneration or de-sulfation (de-SOx) on a diesel engine (about 650-700 °C).

It is known that Pt and Pd supported on a high temperature resistant refractory metal oxide support provides efficient oxidation of CO and HC pollutants emitted from diesel engines. Such DOC compositions are needed by vehicle manufacturers to meet ever more stringent worldwide CO and HC exhaust emission requirements. An additional function of the DOC composition when placed in the exhaust of a diesel vehicle is to oxidize diesel fuel injected into the exhaust upstream of the DOC in order to create a high temperature exotherm that is used to thermally oxidize soot that has accumulated on a diesel particulate filter (DPF) or a catalyzed soot filter (CSF) located downstream of the DOC composition. Alternatively, the hydrocarbon concentration in the exhaust stream can be increased for exotherm generation by adjusting the combustion process through various post-injection methods or the like. Temperatures greater 600 °C at the DPF or CSF inlet are preferred to provide efficient oxidation of the retained soot. The concentration of diesel fuel injected into the exhaust stream needed to provide the desired exotherm is quite high, approximately 1% (10,000 ppm) on a C1 basis or more. The temperature at which the DOC composition can oxidize (“light-off”) the injected fuel needs to be as low as possible, preferably less than 300 °C. In addition, the amount of hydrocarbon slip bypassing the DOC catalyst during exotherm generation needs to be as low as possible, preferably less than 3,000 ppm, 2,000 ppm or even 1,000 ppm.

WO 2022/047132 A1 relates to an oxidation catalyst composition for catalytic articles, exhaust gas treatment systems for reducing formaldehyde levels in engine exhaust emissions. In particular, an oxidation catalyst is disclosed in claim 1 comprising a platinum group metal (PGM) component comprising Pd, Pt, or a combination thereof, a manganese component, and a first refractory metal oxide support material comprising zirconia.

U.S. Pat. No. 10,598,061 B2 relates to methods and systems for a diesel oxidation catalyst. In particular, a method is disclosed in claim 1 comprising: generating NO₂ in a catalyst comprising a washcoat with zirconium, one or more base metal oxides, and a palladium oxide, with an exhaust gas flow rate being between lower and upper threshold flow rates; and facilitating a regeneration of a particulate filter located downstream of the catalyst via NO₂ when an exhaust gas temperature is greater than a threshold temperature where the palladium oxide is contained in an upstream portion of the catalyst relative to a direction of exhaust gas flow; and the one or more base metal oxides are contained in a downstream portion of the catalyst relative to the direction of exhaust gas flow.

U.S. Pat. No. 10,392,980 B2 relates to methods and systems for a diesel oxidation catalyst. In particular, a method is disclosed in claim 1 comprising: passing diesel combustion exhaust gas over a diesel oxidation catalyst having a washcoat comprising zirconium oxide, palladium oxide, and at least one base metal oxide, the washcoat coated on a surface of a substrate with the at least one base metal oxide coated to a downstream portion of the substrate in a greater amount than coated to an upstream portion and the palladium oxide coated to the upstream portion of the substrate in a greater amount than coated to the downstream portion, downstream referring to an axial direction of exhaust gas flow, and where the palladium oxide is 0.5-3 weight percent of the washcoat.

EP 3718627 A1 relates to manganese oxide-lanthanum manganate-PGM composites for TWC applications. In particular, a composition is disclosed in claim 1, the composition comprising a composite of aggregated and/or fused primary particles collectively having a formula of [MnOₓ]_{y}: [La_{z}MnO₃]_{1-y}; wherein x is from about 1 to about 2.5; y is from about 1 to about 30 wt %; z is about 0.7 to about 1.1; and the LazMnO₃ is a crystalline perovskite phase; and wherein the composite of aggregated and/or fused primary particles has a mean surface area of about 25 to about 60 m²/g.

X. Liu et al. disclose in Journal of Rare Earths a comparative study of formaldehyde and carbon monoxide complete oxidation on MnOₓ—CeO₂ catalysts.

X. Wu et al. disclose in Journal of Rare Earths 2012 a study on sulfur poisoning and regeneration of MnOₓ—CeO₂—Al₂O₃ catalyst for soot oxidation.

Considering the tighter regulations being implemented for formaldehyde emissions from the engine exhaust of passenger and delivery vehicles, there was a need to provide an improved catalyst with respect to the treatment of an exhaust gas stream containing one or more of formaldehyde, nitrogen oxide (NO), and hydrocarbons. In particular, there was a need for an improved catalyst suitable for oxidation of one or more of HCHO, nitrogen oxide (NO), and hydrocarbons that can be implemented in medium duty diesel pickup trucks.

### DETAILED DESCRIPTION

It was therefore an object of the present invention to provide a catalyst for the treatment of an exhaust gas stream containing one or more of formaldehyde, nitrogen oxide (NO), and hydrocarbons having improved properties with respect to its performance, in particular after being exposed to a sulfation and de-sulfation treatment.

Surprisingly, it has been found that an improved catalyst can be provided for the conversion of one or more of formaldehyde, nitrogen oxide (NO), and hydrocarbons in an exhaust gas. In particular, it has been surprisingly found that a catalyst can be provided showing an improved performance with respect to the conversion of one or more of formaldehyde, nitrogen oxide (NO), and hydrocarbons after being exposed to a sulfation and de-sulfation treatment as encountered in a typical application. Furthermore, it has been surprisingly found that the catalyst according to the present invention shows enhanced hydrocarbon (HC) and nitrogen oxide (NO) oxidation function. In particular, it has surprisingly been found that the benefit of using BMO-containing catalyst to reduce platinum group metal in diesel exhaust treatment systems is not limited only to HCHO oxidation, but also to hydrocarbon and NO oxidation. This enables vehicle manufacturers to meet ever tightening vehicle emissions standards while also reducing overall PGM usage and costs. It has also been surprisingly found that use of a diesel oxidation catalyst (DOC) comprising both a platinum group metal (PGM) and a base metal oxide (BMO) catalyst leads to a catalyst having enhanced fuel burning function. Furthermore, it can be expected that the catalyst of the present invention is able to oxidize soot accumulation on a substrate, in particular on a wall-flow substrate, especially since the Mn-containing washcoat layer can generate NO₂ which oxidizes soot. Additionally, the catalyst of the present invention can enable a comparatively lower N₂O production, in particular due to its comparatively lower content of platinum group metals.

Therefore, the present invention relates to a catalyst for the treatment of an exhaust gas stream containing one or more of formaldehyde, nitrogen oxide (NO), and hydrocarbons, the catalyst comprising
a first washcoat layer comprising Mn and optionally Ce, wherein Mn and optional Ce are respectively supported on a metal oxide,
a second washcoat layer comprising Mn supported on an oxygen storage component, wherein the oxygen storage component comprises ceria, and
a substrate,
   wherein the substrate has an inlet end through which the exhaust gas stream may enter the catalyst, and an outlet end through which the exhaust gas stream may exit the catalyst,
   wherein the catalyst further comprises one or more platinum group metals comprising Pt, Pd, or Pt and Pd, wherein the one or more platinum group metals are at least in part contained in one or more of:
(a) the first washcoat layer,
(b) the second washcoat layer, and
(c) an optional third washcoat layer, or
(d) optional third and fourth washcoat layers.

Within the meaning of the present invention, an oxygen storage component preferably refers to an entity that has a multi-valence state and can actively react with reductants such as carbon monoxide (CO) and/or hydrogen under reduction conditions and then react with oxidants such as oxygen or nitrogen oxides under oxidative conditions.

It is preferred that the first washcoat layer is substantially free of an oxygen storage component, wherein more preferably the first washcoat layer is free of an oxygen storage component.

Within the meaning of the present invention, a washcoat layer is substantially free of an element or compound(s) when the washcoat layer contains said element or compound(s) in an amount of 1 wt.-% or less calculated as the element or compound(s) and based on 100 wt.-% of the washcoat layer, preferably in an amount of 0.5 wt.-% or less, more preferably of 0.1 wt.-% or less, more preferably of 0.05 wt.-% or less, more preferably of 0.01 wt.-% or less, more preferably of 0.005 wt.-% or less, and more preferably of 0.001 wt.-% or less.

It is preferred that the loading of Mn, calculated as the element, in the first washcoat layer is in the range of from 1 to 50 wt.-% based on 100 wt.-% of the first washcoat layer, more preferably from 2 to 30 wt.-%, more preferably from 5 to 20 wt.-%, more preferably from 8 to 12 wt.-%.

It is preferred that the first washcoat layer comprises Ce, wherein the loading of Ce, calculated as the element, in the first washcoat layer is preferably in the range of from 1 to 50 wt.-% based on 100 wt.-% of the first washcoat layer, more preferably from 2 to 30 wt.-%, more preferably from 5 to 20 wt.-%, more preferably from 8 to 12 wt.-%.

It is preferred that the loading of Mn, calculated as the element, in the second washcoat layer is in the range of from 0.1 to 50 wt.-% based on 100 wt.-% of the second washcoat layer, more preferably from 1 to 40 wt.-%, more preferably from 2 to 30 wt.-%, more preferably from 5 to 20 wt.-%, more preferably from 8 to 12 wt.-%.

It is preferred that the first washcoat layer comprises Cu, wherein more preferably Cu is supported on a metal oxide, wherein the first washcoat layer preferably comprises CuO, Cu₂O, or CuO and Cu₂O, more preferably CuO.

In the case where the first washcoat layer comprises Cu, it is preferred that the loading of Cu, calculated as the element, in the first washcoat layer is in the range of from 1 to 50 wt.-% based on 100 wt.-% of the first washcoat layer, more preferably from 2 to 30 wt.-%, more preferably from 5 to 20 wt.-%, more preferably from 8 to 12 wt.-%.

It is preferred that independently from one another, Mn is present in the form of one or more cations of Mn, wherein Mn is more preferably contained in the first and/or second washcoat layer as one or more oxides, wherein Mn is more preferably contained in the first and/or second washcoat layer as one or more oxides of Mn(II), Mn(III), Mn(II/III), and Mn(IV), more preferably as one or more oxides selected from the group consisting of MnO, Mn₂O₃, Mn₃O₄, MnO₂, Mn(O)OH, and Mn—Zr mixed oxides, including mixtures of two or more thereof, wherein the Mn—Zr mixed oxides are more preferably contained in the first and/or second washcoat layer as a solid solution.

It is preferred that the metal oxide in the first washcoat layer onto which Mn and optional Ce and optional Cu are respectively supported is a particulate support material, wherein the particulate metal oxide support material is more preferably selected from the group consisting of ZrO₂, Al₂O₃, SiO₂, TiO₂, La₂O₃-doped ZrO₂, ZrO₂-doped Al₂O₃, ZrO₂-doped SiO₂, SiO₂-doped Al₂O₃, CeO₂—ZrO₂ mixed oxide, CuO—Al₂O₃ mixed oxide, and mixtures of two or more thereof, more preferably from the group consisting of ZrO₂, La₂O₃-doped ZrO₂, ZrO₂-doped Al₂O₃, ZrO₂-doped SiO₂, TiO₂, and mixtures of two or more thereof, more preferably from the group consisting of ZrO₂, La₂O₃-doped ZrO₂, and mixtures thereof, wherein more preferably Mn and optional Ce and optional Cu are supported on particulate La₂O₃-doped ZrO₂, wherein preferably ZrO₂ is doped with La₂O₃ in an amount ranging from 1 to 50 wt. % based on 100 wt.-% of ZrO₂ and La₂O₃, preferably from 3 to 30 wt.-%, more preferably from 5 to 15 wt.-%, more preferably from 8 to 10 wt.-%.

In the case where the metal oxide in the first washcoat layer onto which Mn and Ce and optional Cu are respectively supported is a particulate support material, it is preferred that the doped particulate metal oxide support materials preferably form a solid solution.

Further in the case where the metal oxide in the first washcoat layer onto which Mn and Ce and optional Cu are respectively supported is a particulate support material, it is preferred that ZrO₂ is doped with La₂O₃ in an amount ranging from 1 to 50 wt. % based on 100 wt.-% of ZrO₂ and La₂O₃, more preferably from 3 to 30 wt.-%, more preferably from 5 to 15 wt.-%, more preferably from 8 to 10 wt.-%.

It is preferred that the loading of the oxygen storage component in the second washcoat layer is in the range of from 5 to 100 wt.-% based on 100 wt.-% of the second washcoat layer, more preferably from 10 to 95 wt.-%, more preferably from 20 to 90 wt.-%, more preferably from 30 to 80 wt.-%, more preferably from 40 to 70 wt.-%.

It is preferred that the oxygen storage component comprises ceria and one or more further metal oxides selected from the group consisting of ZrO₂, La₂O₃, Y₂O₃, Nd₂O₃, Pr₂O₃, and Pr₆O₁₁, including mixtures of two or more thereof, wherein more preferably, the oxygen storage component at least in part displays a fluorite structure, wherein more preferably, the oxygen storage component displays a fluorite structure.

It is preferred that the oxygen storage component comprises, more preferably consists of, CeO₂—ZrO₂ mixed oxide, wherein CeO₂ and ZrO₂ more preferably form a solid solution.

In the case where the oxygen storage component comprises ceria and one or more further metal oxides selected from the group consisting of ZrO₂, La₂O₃, Y₂O₃, Nd₂O₃, Pr₂O₃, and Pr₆O₁₁, including mixtures of two or more thereof, in particular in the case where the oxygen storage component comprises CeO₂—ZrO₂ mixed oxide, it is preferred that the oxygen storage component comprises rare earth metal-doped CeO₂—ZrO₂ mixed oxide,
wherein the rare earth metal-doped CeO₂—ZrO₂ mixed oxide more preferably comprises CeO₂ in an amount in the range of 10 to 95 wt.-%, more preferably in the range of 20 to 90 wt.-%, based on 100 wt.-% of the rare earth metal-doped CeO₂—ZrO₂ mixed oxide,
wherein the CeO₂—ZrO₂ mixed oxide more preferably comprises ZrO₂ in an amount in the range of 5 to 75 wt.-%, more preferably in the range of 9 to 70 wt.-%, based on 100 wt.-% of the rare earth metal-doped CeO₂—ZrO₂ mixed oxide,
wherein the rare earth metal-doped CeO₂—ZrO₂ mixed oxide more preferably comprises La₂O₃ as dopant, preferably in an amount in the range of 1 to 10 wt.-%, more preferably in an amount in the range of 1 to 5 wt.-%, more preferably in the range of 2 to 4 wt.-%, based on 100 wt.-% of the rare earth metal-doped CeO₂—ZrO₂ mixed oxide,
wherein the rare earth metal-doped CeO₂—ZrO₂ mixed oxide more preferably further comprises Y₂O₃ as dopant, preferably in an amount in the range of 1 to 10 wt.-%, more preferably in an amount in the range of 1 to 5 wt.-%, more preferably in the range of 2 to 4 wt.-%, based on 100 wt.-% of the rare earth metal-doped CeO₂—ZrO₂ mixed oxide,
wherein the rare earth metal-doped CeO₂—ZrO₂ mixed oxide more preferably further comprises Nd₂O₃ as dopant, preferably in an amount in the range of 1 to 10 wt.-%, more preferably in an amount in the range of 1 to 5 wt.-%, more preferably in the range of 2 to 4 wt.-%, based on 100 wt.-% of the rare earth metal-doped CeO₂—ZrO₂ mixed oxide,
wherein the rare earth metal-doped CeO₂—ZrO₂ mixed oxide preferably further comprises praseodymium oxide, preferably Pr₂O₃, as dopant, preferably in an amount in the range of 1 to 10 wt. %, more preferably in an amount in the range of 1 to 5 wt.-%, more preferably in the range of 2 to 4 wt.-%, based on 100 wt.-% of the rare earth metal-doped CeO₂—ZrO₂ mixed oxide.

In the case where the oxygen storage component comprises rare earth metal-doped CeO₂—ZrO₂ mixed oxide, it is preferred that the rare earth metal-doped CeO₂—ZrO₂ mixed oxide is doped with La₂O₃, more preferably in an amount in the range of 1 to 20 wt.-%, more preferably in an amount in the range of 5 to 15 wt.-%, more preferably in the range of 9 to 11 wt.-%, based on 100 wt.-% of the rare earth metal-doped CeO₂—ZrO₂ mixed oxide.

It is preferred that independently from one another, the first and/or second washcoat layer further comprises one or more oxides selected from the group consisting of Al₂O₃, SiO₂, SiO₂-doped Al₂O₃, and mixtures of two or more thereof, wherein more preferably the second washcoat layer further comprises Al₂O₃ and/or SiO₂-doped Al₂O₃, more preferably Al₂O₃.

It is preferred that the substrate is a wall-flow substrate or a flow-through substrate, more preferably a honeycomb wall-flow substrate or a honeycomb flow-through substrate, more preferably a honeycomb flow-through substrate, wherein the flow-through substrate is more preferably a flow through substrate with high porosity walls.

It is preferred that the loading of the first washcoat layer is in the range of from 0.5 to 8 g/in³, more preferably of from 0.8 to 7 g/in³, more preferably of from 0.9 to 6 g/in³, more preferably of from 1 to 5 g/in³, more preferably of from 1.5 to 3 g/in³, more preferably of from 1.8 to 2.5 g/in³.

Within the meaning of the present invention, the loading of a washcoat layer in the catalyst refers to the loading of said washcoat layer based on the volume of the catalyst in which said washcoat layer is contained. Accordingly, within the meaning of the present invention, the loading of a washcoat layer only contained in a certain portion or zone of the catalyst is based on the volume of that portion or zone of the catalyst. Thus, by means of examples, if a washcoat layer is provided over 50% of the axial length of a honeycomb substrate, its loading is calculated based on 50% of the total volume of the honeycomb substrate.

It is preferred that the loading of the second washcoat layer is in the range of from 0.1 to 5 g/in³, more preferably of from 0.3 to 3 g/in³, more preferably of from 0.4 to 2.5 g/in³, more preferably of from 0.5 to 2 g/in³, more preferably of from 0.8 to 1.2 g/in³.

It is preferred that the loading of the third washcoat layer is in the range of from 0.25 to 3.0 g/in³, more preferably of from 0.5 to 2.5 g/in³, more preferably of from 1 to 2 g/in³.

It is preferred that the loading of the fourth washcoat layer is in the range of from 0.25 to 3.0 g/in³, more preferably of from 0.5 to 2.5 g/in³, more preferably of from 1 to 2 g/in³.

It is preferred that the catalyst comprises one or more platinum group metals consisting of Pt, Pd, or Pt and Pd, wherein more preferably the catalyst comprises Pt, or Pt and Pd as the one or more platinum group metals, wherein more preferably the catalyst comprises Pt and Pd as the one or more platinum group metals.

It is preferred that the catalyst comprises Pt, calculated as the element, at a loading in the range of from 2 to 250 g/ft³, more preferably of from 5 to 150 g/ft³, more preferably of from 10 to 125 g/ft³, more preferably of from 20 to 100 g/ft³, more preferably of from 25 to 85 g/ft³, more preferably of from 30 to 80 g/ft³, more preferably of from 40 to 60 g/ft³.

Within the meaning of the present invention, the loading of Pt, Pd, or Pt and Pd in the catalyst refers to the loading of Pt, Pd, or Pt and Pd based on the volume of the catalyst in which Pt, Pd, or Pt and Pd is contained. In the event that Pt, Pd, or Pt and Pd is contained in one or more zones of the catalyst, it is preferred within the meaning of the present invention, that the loading of Pt, Pd, or Pt and Pd is based on the volume of the catalyst in which the one or more Pt, Pd, or Pt and Pd zones are contained. Thus, by means of examples, if Pt, Pd, or Pt and Pd is provided in a zone extending over 50% of the axial length of a honeycomb substrate, its loading is calculated based on 50% of the total volume of the honeycomb substrate.

It is preferred that the catalyst comprises Pd, calculated as the element, at a loading in the range of from 1 to 80 g/ft³, more preferably of from 5 to 60 g/ft³, more preferably of from 10 to 50 g/ft³, more preferably of from 15 to 40 g/ft³, more preferably of from 20 to 30 g/ft³.

It is preferred that the catalyst comprises Pt and Pd, calculated as the respective element, at a total Pt and Pd loading in the range of from 2 to 250 g/ft³, more preferably of from 5 to 200 g/ft³, more preferably of from 10 to 150 g/ft³, more preferably of from 20 to 130 g/ft³, more preferably of from 30 to 125 g/ft³, more preferably of from 40 to 110 g/ft³, more preferably of from 50 to 100 g/ft³, more preferably of from 60 to 90 g/ft³, more preferably of from 70 to 80 g/ft³.

It is preferred that the catalyst comprises Pt and Pd at a Pt:Pd weight ratio in the range of from 30:70 to 90:10, more preferably of from 50:50 to 80:20, more preferably of from 60:40 to 75:25, more preferably of from 65:35 to 70:30.

It is preferred that the one or more platinum group metals are supported on a particulate support material, wherein the particulate support material is more preferably selected from the group consisting of Al₂O₃, SiO₂, TiO₂, SiO₂-doped Al₂O₃, Mn oxide-doped Al₂O₃, and mixtures of two or more thereof, wherein more preferably the one or more platinum group metals are supported on Al₂O₃ and/or SiO₂-doped Al₂O₃ and/or Mn oxide-doped Al₂O₃, more preferably SiO₂-doped Al₂O₃ or Al₂O₃ or Mn oxide-doped Al₂O₃, wherein the Mn oxide-doped Al₂O₃ preferably comprises from 1 to 10 weight-%, more preferably from 4 to 6 weight-%, of Mn oxide, calculated as MnO₂, based on 100 weight-% of the Mn oxide-doped Al₂O₃.

It is preferred that the first washcoat layer comprises a hydrocarbon trap material, wherein the hydrocarbon trap material comprises a molecular sieve, preferably a zeolite, more preferably a zeolite having a maximum pore size of 12-membered rings, more preferably zeolite beta, wherein the molecular sieve, preferably the zeolite, preferably comprises SiO₂ and Al₂O₃, wherein the molecular sieve, preferably the zeolite, more preferably has a molar ratio of SiO₂ to Al₂O₃ in the range of from 10:1 to 500:1, more preferably of from 10:1 to 100:1, more preferably of from 10:1 to 40:1, more preferably of from 15:1 to 30:1, more preferably of from 20:1 to 25:1, wherein the molecular sieve, preferably the zeolite, preferably comprises Fe, wherein the molecular sieve, preferably the zeolite, more preferably comprises Fe, calculated as Fe₂O₃, in an amount in the range of from 1.0 to 7.0 weight-%, more preferably of from 3.0 to 5.0 weight-%, more preferably of from 4.0 to 4.5 weight-%, based on the weight of the molecular sieve.

In the case where the first washcoat layer comprises a hydrocarbon trap material, wherein the hydrocarbon trap material comprises a molecular sieve, it is preferred that the loading of the hydrocarbon trap material in the first washcoat layer is in the range of from 0.01 to 2.0 g/in³, preferably in the range of from 0.05 to 1.0 g/in³, more preferably in the range of from 0.05 to 0.3 g/in³.

It is preferred that the second washcoat layer comprises a hydrocarbon trap material, wherein the hydrocarbon trap material comprises a molecular sieve, preferably a zeolite, more preferably a zeolite having a maximum pore size of 12-membered rings, more preferably zeolite beta, wherein the molecular sieve, preferably the zeolite, preferably comprises SiO₂ and Al₂O₃, wherein the molecular sieve, preferably the zeolite, more preferably has a molar ratio of SiO₂ to Al₂O₃ in the range of from 10:1 to 500:1, more preferably of from 10:1 to 100:1, more preferably of from 10:1 to 40:1, more preferably of from 15:1 to 30:1, more preferably of from 20:1 to 25:1, wherein the molecular sieve, preferably the zeolite, preferably comprises Fe, wherein the molecular sieve, preferably the zeolite, more preferably comprises Fe, calculated as Fe₂O₃, in an amount in the range of from 1.0 to 7.0 weight-%, more preferably of from 3.0 to 5.0 weight-%, more preferably of from 4.0 to 4.5 weight-%, based on the weight of the molecular sieve.

In the case where the second washcoat layer comprises a hydrocarbon trap material, wherein the hydrocarbon trap material comprises a molecular sieve, it is preferred that the loading of the hydrocarbon trap material in the second washcoat layer is in the range of from 0.01 to 2.0 g/in³, preferably in the range of from 0.05 to 1.0 g/in³, more preferably in the range of from 0.05 to 0.3 g/in³.

It is preferred that the catalyst comprises a third washcoat layer, wherein the one or more platinum group metals are at least in part contained in the third washcoat layer, wherein more preferably the one or more platinum group metals are entirely contained in the third washcoat layer.

It is preferred that the third washcoat layer comprises a hydrocarbon trap material, wherein the hydrocarbon trap material comprises a molecular sieve, more preferably a zeolite, more preferably a zeolite having a maximum pore size of 12-membered rings, more preferably zeolite beta, wherein the molecular sieve, preferably the zeolite, preferably comprises SiO₂ and Al₂O₃, wherein the molecular sieve, preferably the zeolite, more preferably has a molar ratio of SiO₂ to Al₂O₃ in the range of from 10:1 to 500:1, more preferably of from 10:1 to 100:1, more preferably of from 10:1 to 40:1, more preferably of from 15:1 to 30:1, more preferably of from 20:1 to 25:1, wherein the molecular sieve, preferably the zeolite, preferably comprises Fe, wherein the molecular sieve, preferably the zeolite, more preferably comprises Fe, calculated as Fe₂O₃, in an amount in the range of from 1.0 to 7.0 weight-%, more preferably of from 3.0 to 5.0 weight-%, more preferably of from 4.0 to 4.5 weight-%, based on the weight of the molecular sieve.

In the case where the third washcoat layer comprises a hydrocarbon trap material, wherein the hydrocarbon trap material comprises a molecular sieve, it is preferred that the loading of the hydrocarbon trap material in the third washcoat layer is in the range of from 0.01 to 2.0 g/in³, more preferably in the range of from 0.05 to 1.0 g/in³, more preferably in the range of from 0.05 to 0.3 g/in³.

According to a first alternative, it is preferred that the catalyst displays a layered arrangement of the first and second washcoat layers, wherein the first washcoat layer is provided on the substrate, and wherein the second washcoat layer is provided on the first washcoat layer.

According to a second alternative, it is preferred that the catalyst displays a layered arrangement of the first and second washcoat layers, wherein the second washcoat layer is provided on the substrate, and wherein the first washcoat layer is provided on the second washcoat layer.

In the case where the catalyst displays a layered arrangement of the first and second washcoat layers in accordance with the first or second alternative, it is preferred that the one or more platinum group metals are at least in part contained in the second washcoat layer, wherein preferably the one or more platinum group metals are entirely contained in the second washcoat layer.

Further in the case where the catalyst displays a layered arrangement of the first and second washcoat layers in accordance with the first or second alternative, it is preferred that the one or more platinum group metals are at least in part contained in the first washcoat layer, wherein more preferably the one or more platinum group metals are entirely contained in the first washcoat layer.

According to a third alternative, it is preferred that the catalyst comprises a third washcoat layer, wherein the catalyst displays a layered arrangement of the first, second, and third washcoat layers, wherein the first washcoat layer is provided on the substrate, the second washcoat layer is provided on the first washcoat layer, and the third washcoat layer is provided on the second washcoat layer.

In the case where the catalyst comprises a third washcoat layer, wherein the catalyst displays a layered arrangement of the first, second, and third washcoat layers according to the third alternative, it is preferred that the catalyst comprises a fourth washcoat layer, wherein the fourth washcoat layer is provided on the second layer, wherein the catalyst displays a zoned arrangement of the third and fourth washcoat layers, wherein the third washcoat layer is provided on the second washcoat layer along the axial length of the substrate starting from the inlet end of the substrate, and wherein the fourth washcoat layer is provided on the second washcoat layer along the axial length of the substrate starting from the outlet end of the substrate, wherein the length of the fourth washcoat layer is less than the axial length of the substrate such as to create an upstream zone comprising the third washcoat layer and a downstream zone comprising the fourth washcoat layer. Alternatively, it is preferred that the catalyst comprises a fourth washcoat layer, wherein the fourth washcoat layer is provided on the second layer, wherein the catalyst displays a zoned arrangement of the third and fourth washcoat layers, wherein the fourth washcoat layer is provided on the second washcoat layer along the axial length of the substrate starting from the inlet end of the substrate, and wherein the third washcoat layer is provided on the second washcoat layer along the axial length of the substrate starting from the outlet end of the substrate, wherein the length of the fourth washcoat layer is less than the axial length of the substrate such as to create an upstream zone comprising the fourth washcoat layer and a downstream zone comprising the third washcoat layer. It is particularly preferred that the third and fourth washcoat layers are adjacent to one another.

Further in the case where the catalyst comprises a third washcoat layer, wherein the catalyst displays a layered arrangement of the first, second, and third washcoat layers according to the third alternative, it is preferred that the one or more platinum group metals are at least in part contained in the third washcoat layer and/or in the fourth washcoat layer, wherein preferably the one or more platinum group metals are entirely contained in the third and fourth washcoat layers.

According to a fourth alternative, it is preferred that the catalyst comprises a third washcoat layer, wherein the catalyst displays a layered arrangement of the first, second, and third washcoat layers, wherein the first washcoat layer is provided on the substrate, the third washcoat layer is provided on the first washcoat layer, and the second washcoat layer is provided on the third washcoat layer.

According to a fifth alternative, it is preferred that the catalyst comprises a third washcoat layer, wherein the catalyst displays a layered arrangement of the first, second, and third washcoat layers, wherein the second washcoat layer is provided on the substrate, the first washcoat layer is provided on the second washcoat layer, and the third washcoat layer is provided on the first washcoat layer.

In the case where the catalyst comprises a third washcoat layer, wherein the catalyst displays a layered arrangement of the first, second, and third washcoat layers according to the fifth alternative, it is preferred that the catalyst comprises a fourth washcoat layer, wherein the fourth washcoat layer is provided on the first layer, wherein the catalyst displays a zoned arrangement of the third and fourth washcoat layers, wherein the third washcoat layer is provided on the first washcoat layer along the axial length of the substrate starting from the inlet end of the substrate, and wherein the fourth washcoat layer is provided on the first washcoat layer along the axial length of the substrate starting from the outlet end of the substrate, wherein the length of the fourth washcoat layer is less than the axial length of the substrate such as to create an upstream zone comprising the third washcoat layer and a downstream zone comprising the fourth washcoat layer. Alternatively, it is preferred that the catalyst comprises a fourth washcoat layer, wherein the fourth washcoat layer is provided on the first layer, wherein the catalyst displays a zoned arrangement of the third and fourth washcoat layers, wherein the fourth washcoat layer is provided on the first washcoat layer along the axial length of the substrate starting from the inlet end of the substrate, and wherein the third washcoat layer is provided on the first washcoat layer along the axial length of the substrate starting from the outlet end of the substrate, wherein the length of the fourth washcoat layer is less than the axial length of the substrate such as to create an upstream zone comprising the fourth washcoat layer and a downstream zone comprising the third washcoat layer. It is particularly preferred that the third and fourth washcoat layers are adjacent to one another.

Further in the case where the catalyst comprises a third washcoat layer, wherein the catalyst displays a layered arrangement of the first, second, and third washcoat layers according to the fifth alternative, it is preferred that the one or more platinum group metals are at least in part contained in the third washcoat layer and/or in the fourth washcoat layer, wherein preferably the one or more platinum group metals are entirely contained in the third and fourth washcoat layers.

According to a sixth alternative, it is preferred that the catalyst comprises a third washcoat layer, wherein the catalyst displays a layered arrangement of the first, second, and third washcoat layers, wherein the second washcoat layer is provided on the substrate, the third washcoat layer is provided on the second washcoat layer, and the first washcoat layer is provided on the third washcoat layer.

In the case where the catalyst comprises a third washcoat layer, wherein the catalyst displays a layered arrangement of the first, second, and third washcoat layers in accordance with the third, fourth, fifth or sixth alternative, it is preferred that the one or more platinum group metals are at least in part contained in the third washcoat layer, wherein more preferably the one or more platinum group metals are entirely contained in the third washcoat layer.

According to a seventh alternative, it is preferred that the catalyst displays a zoned arrangement of the first and second washcoat layers, wherein the second washcoat layer is provided on the substrate along its axial length starting from the inlet end of the substrate, and wherein the first washcoat layer is provided on the substrate along its axial length starting from the outlet end of the substrate, wherein the length of the first washcoat layer is less than the axial length of the substrate such as to create an upstream zone comprising the second washcoat layer and a downstream zone comprising the first washcoat layer.

According to an eighth alternative, it is preferred that the catalyst displays a zoned arrangement of the first and second washcoat layers, wherein the second washcoat layer is provided on the substrate along its axial length starting from the outlet end of the substrate, and wherein the first washcoat layer is provided on the substrate along its axial length starting from the inlet end of the substrate, wherein the length of the first washcoat layer is less than the axial length of the substrate such as to create an upstream zone comprising the first washcoat layer and a downstream zone comprising the second washcoat layer.

According to a ninth alternative, it is preferred that the catalyst displays a zoned arrangement of the first and second washcoat layers, wherein the second washcoat layer is provided on the substrate along its axial length starting from the inlet end of the substrate, and wherein the first washcoat layer is provided on the substrate along its axial length starting from the outlet end of the substrate, wherein the length of the second washcoat layer is less than the axial length of the substrate such as to create an upstream zone comprising the second washcoat layer and a downstream zone comprising the first washcoat layer.

According to a tenth alternative, it is preferred that the catalyst displays a zoned arrangement of the first and second washcoat layers, wherein the second washcoat layer is provided on the substrate along its axial length starting from the outlet end of the substrate, and wherein the first washcoat layer is provided on the substrate along its axial length starting from the inlet end of the substrate, wherein the length of the second washcoat layer is less than the axial length of the substrate such as to create an upstream zone comprising the first washcoat layer and a downstream zone comprising the second washcoat layer.

In the case where the catalyst comprises a third washcoat layer, wherein the catalyst displays a layered arrangement of the first, second, and third washcoat layers in accordance with the seventh, eighth, ninth or tenth alternative, it is preferred that the one or more platinum group metals are at least in part contained in the second washcoat layer, wherein more preferably the one or more platinum group metals are entirely contained in the second washcoat layer.

Further in the case where the catalyst comprises a third washcoat layer, wherein the catalyst displays a layered arrangement of the first, second, and third washcoat layers in accordance with the seventh, eighth, ninth or tenth alternative, it is preferred that the one or more platinum group metals are at least in part contained in the first washcoat layer, wherein preferably the one or more platinum group metals are entirely contained in the first washcoat layer.

Further in the case where the catalyst comprises a third washcoat layer, wherein the catalyst displays a layered arrangement of the first, second, and third washcoat layers in accordance with the seventh, eighth, ninth or tenth alternative, it is preferred that the first and second washcoat layers are adjacent to one another.

Further in the case where the catalyst comprises a third washcoat layer, wherein the catalyst displays a layered arrangement of the first, second, and third washcoat layers in accordance with the seventh, eighth, ninth or tenth alternative, it is preferred that a portion of the second washcoat layer overlaps at least a portion of the first washcoat layer, wherein more preferably the second washcoat layer overlaps the first washcoat layer over a portion ranging from 5 to 100% of the axial length of the substrate, more preferably from 10 to 100% of the axial length of the first washcoat layer, more preferably from 15 to 80%, and more preferably from 20 to 50%.

Further in the case where the catalyst comprises a third washcoat layer, wherein the catalyst displays a layered arrangement of the first, second, and third washcoat layers in accordance with the seventh, eighth, ninth or tenth alternative, it is preferred that a portion of the first washcoat layer overlaps at least a portion of the second washcoat layer, wherein more preferably the first washcoat layer overlaps the second washcoat layer over a portion ranging from 5 to 100% of the axial length of the substrate, more preferably from 10 to 100% of the axial length of the second washcoat layer, more preferably from 15 to 80%, and more preferably from 20 to 50%.

According to an eleventh alternative, it is preferred that the catalyst comprises a third washcoat layer, wherein the catalyst displays a zoned arrangement of the first, second, and third washcoat layers, wherein the third washcoat layer is provided on the substrate along its axial length starting from the inlet end of the substrate and wherein the first washcoat layer is provided on the substrate along its axial length starting from the outlet end of the substrate, and wherein the second washcoat layer is provided on the first washcoat layer from the outlet end of the substrate, wherein the length of the first washcoat layer is less than the axial length of the substrate such a to create an upstream zone comprising the third washcoat layer and a downstream zone comprising the first and second washcoat layers, and wherein the one or more platinum group metals are at least in part contained in the third washcoat layer.

In the case where the catalyst comprises a third washcoat layer, wherein the catalyst displays a zoned arrangement of the first, second, and third washcoat layers in accordance with the eleventh alternative, it is preferred that the first and third washcoat layers are adjacent to one another.

Further in the case where the catalyst comprises a third washcoat layer, wherein the catalyst displays a zoned arrangement of the first, second, and third washcoat layers in accordance with the eleventh alternative, it is preferred that the second and third washcoat layers are adjacent to one another.

Further in the case where the catalyst comprises a third washcoat layer, wherein the catalyst displays a zoned arrangement of the first, second, and third washcoat layers in accordance with the eleventh alternative, it is preferred that a portion of the second washcoat layer overlaps at least a portion of the third washcoat layer, wherein more preferably the second washcoat layer overlaps the third washcoat layer over a portion ranging from 5 to 100% of the axial length of the substrate, more preferably from 10 to 100% of the axial length of the third washcoat layer, more preferably from 15 to 80%, and more preferably from 20 to 50%.

In the case where the catalyst comprises a third washcoat layer, wherein the catalyst displays a zoned arrangement of the first, second, and third washcoat layers according to the eleventh alternative, it is preferred that the catalyst comprises a fourth washcoat layer, wherein the fourth washcoat layer is provided on the second layer, wherein the catalyst displays a zoned arrangement of the third and fourth washcoat layers, wherein the third washcoat layer is at least partially provided on the substrate along the axial length of the substrate starting from the inlet end of the substrate, and wherein the fourth washcoat layer is provided on the second washcoat layer along the axial length of the substrate starting from the outlet end of the substrate, wherein the length of the fourth washcoat layer is less than the axial length of the substrate such as to create an upstream zone comprising the third washcoat layer and a downstream zone comprising the first, second and fourth washcoat layers.

According to a twelfth alternative, it is preferred that the catalyst comprises a third washcoat layer, wherein the catalyst displays a zoned arrangement of the first, second, and third washcoat layers, wherein the third washcoat layer is provided on the substrate along its axial length starting from the inlet end of the substrate and wherein the second washcoat layer is provided on the substrate along its axial length starting from the outlet end of the substrate, and wherein the first washcoat layer is provided on the second washcoat layer from the outlet end of the substrate, wherein the length of the second washcoat layer is less than the axial length of the substrate such a to create an upstream zone comprising the third washcoat layer and a downstream zone comprising the first and second washcoat layers, and wherein the one or more platinum group metals are at least in part contained in the third washcoat layer.

In the case where the catalyst comprises a third washcoat layer, wherein the catalyst displays a zoned arrangement of the first, second, and third washcoat layers in accordance with the twelfth alternative, it is preferred that the second and third washcoat layers are adjacent to one another.

Further in the case where the catalyst comprises a third washcoat layer, wherein the catalyst displays a zoned arrangement of the first, second, and third washcoat layers in accordance with the twelfth alternative, it is preferred that the first and third washcoat layers are adjacent to one another.

Further in the case where the catalyst comprises a third washcoat layer, wherein the catalyst displays a zoned arrangement of the first, second, and third washcoat layers in accordance with the twelfth alternative, it is preferred that a portion of the first washcoat layer overlaps at least a portion of the third washcoat layer, wherein more preferably the first washcoat layer overlaps the third washcoat layer over a portion ranging from 5 to 100% of the axial length of the substrate, more preferably from 10 to 100% of the axial length of the third washcoat layer, more preferably from 15 to 80%, and more preferably from 20 to 50%.

In the case where the catalyst comprises a third washcoat layer, wherein the catalyst displays a zoned arrangement of the first, second, and third washcoat layers according to the twelfth alternative, it is preferred that the catalyst comprises a fourth washcoat layer, wherein the fourth washcoat layer is provided on the first layer, wherein the catalyst displays a zoned arrangement of the third and fourth washcoat layers, wherein the third washcoat layer is at least partially provided on the substrate along the axial length of the substrate starting from the inlet end of the substrate, and wherein the fourth washcoat layer is provided on the first washcoat layer along the axial length of the substrate starting from the outlet end of the substrate, wherein the length of the fourth washcoat layer is less than the axial length of the substrate such as to create an upstream zone comprising the third washcoat layer and a downstream zone comprising the first, second and fourth washcoat layers.

According to a thirteenth alternative, it is preferred that the catalyst comprises a third washcoat layer, wherein the catalyst displays a zoned arrangement of the first, second, and third washcoat layers, wherein the third washcoat layer is provided on the substrate along its axial length starting from the outlet end of the substrate and wherein the first washcoat layer is provided on the substrate along its axial length starting from the inlet end of the substrate, and wherein the second washcoat layer is provided on the first washcoat layer from the inlet end of the substrate, wherein the length of the first washcoat layer is less than the axial length of the substrate such a to create a downstream zone comprising the third washcoat layer and an upstream zone comprising the first and second washcoat layers, and wherein the one or more platinum group metals are at least in part contained in the third washcoat layer.

In the case where the that the catalyst comprises a third washcoat layer, wherein the catalyst displays a zoned arrangement of the first, second, and third washcoat layers in accordance with the thirteenth alternative, it is preferred that the first and third washcoat layers are adjacent to one another.

Further in the case where the that the catalyst comprises a third washcoat layer, wherein the catalyst displays a zoned arrangement of the first, second, and third washcoat layers in accordance with the thirteenth alternative, it is preferred that the second and third washcoat layers are adjacent to one another. Alternatively, it is preferred that a portion of the second washcoat layer overlaps at least a portion of the third washcoat layer, wherein more preferably the second washcoat layer overlaps the third washcoat layer over a portion ranging from 5 to 100% of the axial length of the substrate, more preferably from 10 to 100% of the axial length of the third washcoat layer, more preferably from 15 to 80%, and more preferably from 20 to 50%.

In the case where the catalyst comprises a third washcoat layer, wherein the catalyst displays a zoned arrangement of the first, second, and third washcoat layers according to the thirteenth alternative, it is preferred that the catalyst comprises a fourth washcoat layer, wherein the fourth washcoat layer is provided on the second layer, wherein the catalyst displays a zoned arrangement of the third and fourth washcoat layers, wherein the third washcoat layer is at least partially provided on the substrate along the axial length of the substrate starting from the outlet end of the substrate, and wherein the fourth washcoat layer is provided on the second washcoat layer along the axial length of the substrate starting from the inlet end of the substrate, wherein the length of the fourth washcoat layer is less than the axial length of the substrate such as to create an upstream zone comprising the first, second and fourth washcoat layers and a downstream zone comprising the third washcoat layer.

According to a fourteenth alternative, it is preferred that the catalyst comprises a third washcoat layer, wherein the catalyst displays a zoned arrangement of the first, second, and third washcoat layers, wherein the third washcoat layer is provided on the substrate along its axial length starting from the outlet end of the substrate and wherein the second washcoat layer is provided on the substrate along its axial length starting from the inlet end of the substrate, and wherein the first washcoat layer is provided on the second washcoat layer from the inlet end of the substrate, wherein the length of the second washcoat layer is less than the axial length of the substrate such a to create a downstream zone comprising the third washcoat layer and an upstream zone comprising the first and second washcoat layers, and wherein the one or more platinum group metals are at least in part contained in the third washcoat layer.

In the case where the catalyst comprises a third washcoat layer, wherein the catalyst displays a zoned arrangement of the first, second, and third washcoat layers in accordance with the fourteenth alternative, it is preferred that the second and third washcoat layers are adjacent to one another.

Further in the case where the catalyst comprises a third washcoat layer, wherein the catalyst displays a zoned arrangement of the first, second, and third washcoat layers in accordance with the fourteenth alternative, it is preferred that the first and third washcoat layers are adjacent to one another. Alternatively, it is preferred that a portion of the first washcoat layer overlaps at least a portion of the third washcoat layer, wherein more preferably the first washcoat layer overlaps the third washcoat layer over a portion ranging from 5 to 100% of the axial length of the substrate, more preferably from 10 to 100% of the axial length of the third washcoat layer, more preferably from 15 to 80%, and more preferably from 20 to 50%.

In the case where the catalyst comprises a third washcoat layer, wherein the catalyst displays a zoned arrangement of the first, second, and third washcoat layers according to the fourteenth alternative, it is preferred that the catalyst comprises a fourth washcoat layer, wherein the fourth washcoat layer is provided on the first layer, wherein the catalyst displays a zoned arrangement of the third and fourth washcoat layers, wherein the third washcoat layer is at least partially provided on the substrate along the axial length of the substrate starting from the outlet end of the substrate, and wherein the fourth washcoat layer is provided on the first washcoat layer along the axial length of the substrate starting from the inlet end of the substrate, wherein the length of the fourth washcoat layer is less than the axial length of the substrate such as to create an upstream zone comprising the first, second and fourth washcoat layers and a downstream zone comprising the third washcoat layer.

In the case where the catalyst comprises a third washcoat layer, wherein the catalyst displays a zoned arrangement of the first, second, and third washcoat layers according to the eleventh alternative, it is preferred that a portion of the third washcoat layer overlaps at least a portion of the second washcoat layer, wherein preferably the third washcoat layer overlaps the second washcoat layer over a portion ranging from 10 to 100% of the axial length of the second washcoat layer, more preferably from 15 to 80%, and more preferably from 20 to 50%. In this case, it is particularly preferred that the catalyst comprises a fourth washcoat layer, wherein the fourth washcoat layer is provided on the second layer, wherein the catalyst displays a zoned arrangement of the third and fourth washcoat layers, wherein the third washcoat layer is at least partially provided on the substrate along the axial length of the substrate starting from the inlet end of the substrate, and wherein the fourth washcoat layer is provided on the second washcoat layer along the axial length of the substrate starting from the outlet end of the substrate, wherein the length of the fourth washcoat layer is less than the axial length of the substrate such as to create an upstream zone comprising the third washcoat layer and a downstream zone comprising the fourth washcoat layer.

In the case where the catalyst comprises a third washcoat layer, wherein the catalyst displays a zoned arrangement of the first, second, and third washcoat layers according to the thirteenth alternative, it is preferred that a portion of the third washcoat layer overlaps at least a portion of the second washcoat layer, wherein preferably the third washcoat layer overlaps the second washcoat layer over a portion ranging from 10 to 100% of the axial length of the second washcoat layer, more preferably from 15 to 80%, and more preferably from 20 to 50%. In this case, it is particularly preferred that the catalyst comprises a fourth washcoat layer, wherein the fourth washcoat layer is provided on the second layer, wherein the catalyst displays a zoned arrangement of the third and fourth washcoat layers, wherein the third washcoat layer is at least partially provided on the substrate along the axial length of the substrate starting from the outlet end of the substrate, and wherein the fourth washcoat layer is provided on the second washcoat layer along the axial length of the substrate starting from the inlet end of the substrate, wherein the length of the fourth washcoat layer is less than the axial length of the substrate such as to create an upstream zone comprising the fourth washcoat layer and a downstream zone comprising the third washcoat layer.

In the case where the catalyst comprises a third washcoat layer, wherein the catalyst displays a zoned arrangement of the first, second, and third washcoat layers according to the twelvth alternative, it is preferred that a portion of the third washcoat layer overlaps at least a portion of the first washcoat layer, wherein preferably the third washcoat layer overlaps the first washcoat layer over a portion ranging from 10 to 100% of the axial length of the first washcoat layer, more preferably from 15 to 80%, and more preferably from 20 to 50%. In this case, it is particularly preferred that the catalyst comprises a fourth washcoat layer, wherein the fourth washcoat layer is provided on the first layer, wherein the catalyst displays a zoned arrangement of the third and fourth washcoat layers, wherein the third washcoat layer is at least partially provided on the substrate along the axial length of the substrate starting from the inlet end of the substrate, and wherein the fourth washcoat layer is provided on the first washcoat layer along the axial length of the substrate starting from the outlet end of the substrate, wherein the length of the fourth washcoat layer is less than the axial length of the substrate such as to create an upstream zone comprising the third washcoat layer and a downstream zone comprising the fourth washcoat layer. In this case, it is particularly preferred that the catalyst comprises a fourth washcoat layer, wherein the fourth washcoat layer is provided on the second layer, wherein the catalyst displays a zoned arrangement of the third and fourth washcoat layers, wherein the third washcoat layer is at least partially provided on the substrate along the axial length of the substrate starting from the outlet end of the substrate, and wherein the fourth washcoat layer is provided on the first washcoat layer along the axial length of the substrate starting from the inlet end of the substrate, wherein the length of the fourth washcoat layer is less than the axial length of the substrate such as to create an upstream zone comprising the fourth washcoat layer and a downstream zone comprising the third washcoat layer.

In the case where the catalyst comprises a third washcoat layer, wherein the catalyst displays a zoned arrangement of the first, second, and third washcoat layers according to the fourteenth alternative, it is preferred that a portion of the third washcoat layer overlaps at least a portion of the first washcoat layer, wherein preferably the third washcoat layer overlaps the first washcoat layer over a portion ranging from 10 to 100% of the axial length of the first washcoat layer, more preferably from 15 to 80%, and more preferably from 20 to 50%. In this case, it is particularly preferred that the catalyst comprises a fourth washcoat layer, wherein the fourth washcoat layer is provided on the second layer, wherein the catalyst displays a zoned arrangement of the third and fourth washcoat layers, wherein the third washcoat layer is at least partially provided on the substrate along the axial length of the substrate starting from the outlet end of the substrate, and wherein the fourth washcoat layer is provided on the first washcoat layer along the axial length of the substrate starting from the inlet end of the substrate, wherein the length of the fourth washcoat layer is less than the axial length of the substrate such as to create an upstream zone comprising the fourth washcoat layer and a downstream zone comprising the third washcoat layer.

It is preferred that the third and fourth washcoat layers are adjacent to one another.

In the case where the catalyst displays a layered arrangement of the first, second and optional third washcoat layers in accordance with the first, second, third, fourth, fifth, sixth, seventh, eighth, ninth, tenth, eleventh, twelfth, thirteenth or fourteenth alternative, it is preferred that the length of the first washcoat layer ranges from 5 to 100% of the axial length of the substrate, more preferably from 10 to 90% of the axial length of the substrate, more preferably from 30 to 80%, more preferably from 45 to 75%, and more preferably from 50 to 70%.

Further in the case where the catalyst displays a layered arrangement of the first, second and optional third washcoat layers in accordance with the first, second, third, fourth, fifth, sixth, seventh, eighth, ninth, tenth, eleventh, twelfth, thirteenth or fourteenth alternative, it is preferred that the length of the second washcoat layer ranges from 5 to 100% of the axial length of the substrate, more preferably from 10 to 90% of the axial length of the substrate, more preferably from 30 to 80%, more preferably from 45 to 75%, and more preferably from 50 to 70%.

It is preferred that the one or more platinum group metals are entirely contained in the third washcoat layer or in the third and fourth washcoat layers.

It is preferred that the length of the third washcoat layer ranges from 5 to 100% of the axial length of the substrate, more preferably from 10 to 90% of the axial length of the substrate, preferably from 20 to 60%, and more preferably from 35 to 45%.

In the case where the catalyst comprises the fourth washcoat layer, it is preferred that the length of the fourth washcoat layer ranges from 5 to 100% of the axial length of the substrate, preferably from 10 to 90% of the axial length of the substrate, more preferably from 20 to 60%, and more preferably from 35 to 45%.

Further in the case where the catalyst comprises the fourth washcoat layer, it is preferred that the fourth washcoat layer comprises a hydrocarbon trap material, wherein the hydrocarbon trap material comprises a molecular sieve, preferably a zeolite, more preferably a zeolite having a maximum pore size of 12-membered rings, more preferably zeolite beta, wherein the molecular sieve, preferably the zeolite, preferably comprises SiO₂ and Al₂O₃, wherein the molecular sieve, preferably the zeolite, more preferably has a molar ratio of SiO₂ to Al₂O₃ in the range of from 10:1 to 500:1, more preferably of from 10:1 to 100:1, more preferably of from 10:1 to 40:1, more preferably of from 15:1 to 30:1, more preferably of from 20:1 to 25:1, wherein the molecular sieve, preferably the zeolite, preferably comprises Fe, wherein the molecular sieve, preferably the zeolite, more preferably comprises Fe, calculated as Fe₂O₃, in an amount in the range of from 1.0 to 7.0 weight-%, more preferably of from 3.0 to 5.0 weight-%, more preferably of from 4.0 to 4.5 weight-%, based on the weight of the molecular sieve.

In the case where the fourth washcoat layer comprises a hydrocarbon trap material, it is preferred that the loading of the hydrocarbon trap material in the fourth washcoat layer is in the range of from 0.01 to 2.0 g/in³, preferably in the range of from 0.05 to 1.0 g/in³, more preferably in the range of from 0.05 to 0.3 g/in³.

Further in the case where the catalyst comprises the fourth washcoat layer, it is preferred that the one or more platinum group metals are at least in part contained in the fourth washcoat layer.

In the case where the one or more platinum group metals are at least in part contained in the fourth washcoat layer, it is preferred that the one or more platinum group metals are supported on a particulate support material, wherein the particulate support material is preferably selected from the group consisting of Al₂O₃, SiO₂, TiO₂, SiO₂-doped Al₂O₃, Mn oxide-doped Al₂O₃, and mixtures of two or more thereof, wherein preferably the one or more platinum group metals are supported on Al₂O₃ and/or SiO₂-doped Al₂O₃ and/or Mn oxide-doped Al₂O₃, more preferably SiO₂-doped Al₂O₃ or Al₂O₃ or Mn oxide-doped Al₂O₃, wherein the Mn oxide-doped Al₂O₃ preferably comprises from 1 to 10 weight-%, more preferably from 4 to 6 weight-%, of Mn oxide, calculated as MnO₂, based on 100 weight-% of the Mn oxide-doped Al₂O₃.

Further in the case where the catalyst comprises the fourth washcoat layer, it is preferred that the catalyst comprises third and fourth washcoat layers, wherein the one or more platinum group metals are entirely contained in the third and fourth washcoat layers, wherein the weight ratio of the one or more platinum group metals comprised in the third washcoat layer to the one or more platinum group metals comprised in the fourth washcoat layer is in the range of from 0.5:1 to 5.0:1, more preferably 1.0:1 to 2.0:1, more preferably in the range of from 1.4:1 to 1.6:1, wherein the one or more platinum group metals comprised in the third washcoat layer preferably comprise, more preferably consist of, Pt and Pd, wherein the one or more platinum group metals comprised in the fourth washcoat layer preferably comprise, more preferably consist of, Pt and Pd.

Further in the case where the catalyst comprises the fourth washcoat layer, it is preferred that the one or more platinum group metals are entirely contained in the third washcoat layer and/or in the optional fourth washcoat layer.

It is preferred that the substrate is a metallic substrate or a ceramic substrate, wherein preferably the substrate is a ceramic substrate, wherein more preferably the substrate comprises cordierite and/or SIC, preferably cordierite, wherein more preferably, the substrate consists cordierite and/or SIC, preferably of cordierite.

In the case where the catalyst displays a zoned arrangement of the first, second and optional third washcoat layers in accordance with the seventh, eighth, ninth, tenth, eleventh, twelfth, thirteenth or fourteenth alternative, it is preferred that the substrate consists of two separate monoliths, wherein the first monolith is provided upstream of the second monolith, wherein the washcoat layer or washcoat layers of the upstream zone are contained on the first monolith, and the washcoat layer or washcoat layers of the downstream zone are contained on the second monolith, wherein more preferably the first monolith containing the washcoat layer or washcoat layers of the upstream zone and the second monolith containing the washcoat layer or washcoat layers of the downstream zone are obtained or obtainable by sectioning of a catalyst according to any one of the embodiments disclosed herein being in accordance with the seventh, eighth, ninth, tenth, eleventh, twelfth, thirteenth or fourteenth alternative into two separate monoliths, wherein the washcoat layer or washcoat layers of the upstream zone are contained on the first monolith, and the washcoat layer or washcoat layers of the downstream zone are contained on the second monolith.

It is preferred that the exhaust gas stream contains hydrocarbons, preferably C1 to C20 hydrocarbons, more preferably C2 to C10 hydrocarbons.

Further, the present invention relates to an exhaust gas treatment system comprising an internal combustion engine and an exhaust gas conduit for exhaust gas from the internal combustion engine, wherein the exhaust gas conduit comprises one or more catalysts according to any one of the embodiments disclosed herein, preferably one, two, three, or four catalysts according to any one of the embodiments disclosed herein.

It is preferred that the internal combustion engine is a compression ignition engine, more preferably a diesel engine.

It is preferred that the internal combustion engine is a lean gasoline engine.

Alternatively, it is preferred that the internal combustion engine is powered by an oxygenated fuel, wherein the oxygenated fuel more preferably comprises one or more of methanol and biofuel.

It is preferred that the system comprises one or more of an electric heater, a fuel burner, a fuel injector, a selective catalytic reduction (SCR) catalyst, an ammonia oxidation (AMOX) catalyst, a catalyzed soot filter (CSF), a diesel particulate filter (DPF), a selective catalytic reduction catalyst on filter (SCROF), and a diesel exotherm catalyst (DEC).

According to a first alternative, it is preferred that the system comprises in consecutive order in the direction of the exhaust gas: optionally an electric heater or a fuel burner and/or a fuel injector, a catalyst according to any of the embodiments disclosed herein, a catalyst according to any of the embodiments disclosed herein, a selective catalytic reduction (SCR) catalyst, a selective catalytic reduction (SCR) catalyst, an optional fuel injector, a diesel exotherm catalyst (DEC), a catalyzed soot filter (CSF), a selective catalytic reduction (SCR) catalyst, and a selective catalytic reduction (SCR) catalyst.

According to a second alternative, it is preferred that the system comprises in consecutive order in the direction of the exhaust gas: optionally an electric heater or a fuel burner and/or a fuel injector, a catalyst according to any of the embodiments disclosed herein, a catalyst according to any of the embodiments disclosed herein, a selective catalytic reduction (SCR) catalyst, a selective catalytic reduction (SCR) catalyst, an optional fuel injector, a diesel exotherm catalyst (DEC), a diesel particulate filter (DPF), a selective catalytic reduction (SCR) catalyst, and a selective catalytic reduction (SCR) catalyst.

According to a third alternative, it is preferred that the system comprises in consecutive order in the direction of the exhaust gas: optionally an electric heater or a fuel burner and/or a fuel injector, a catalyst according to any of the embodiments disclosed herein, a catalyst according to any of the embodiments disclosed herein, a selective catalytic reduction (SCR) catalyst, a selective catalytic reduction (SCR) catalyst, an optional fuel injector, a diesel exotherm catalyst (DEC), a diesel particulate filter (DPF), a selective catalytic reduction (SCR) catalyst, and an ammonia oxidation (AMOX) catalyst.

According to a fourth alternative, it is preferred that the system comprises in consecutive order in the direction of the exhaust gas: optionally an electric heater or a fuel burner and/or a fuel injector, a catalyst according to any of the embodiments disclosed herein, a catalyst according to any of the embodiments disclosed herein, a selective catalytic reduction (SCR) catalyst, a selective catalytic reduction (SCR) catalyst, an optional fuel injector, a catalyst according to any of the embodiments disclosed herein, a diesel particulate filter (DPF), a selective catalytic reduction (SCR) catalyst, and a selective catalytic reduction (SCR) catalyst.

According to a fifth alternative, it is preferred that the system comprises in consecutive order in the direction of the exhaust gas: optionally an electric heater or a fuel burner and/or a fuel injector, a catalyst according to any of the embodiments disclosed herein, a catalyst according to any of the embodiments disclosed herein, a selective catalytic reduction (SCR) catalyst, a selective catalytic reduction (SCR) catalyst, an optional fuel injector, a catalyst according to any of the embodiments disclosed herein, a catalyst according to any of the embodiments disclosed herein, wherein the substrate is a wall-flow substrate, a selective catalytic reduction (SCR) catalyst, and an ammonia oxidation (AMOX) catalyst.

According to a sixth alternative, it is preferred that the system comprises in consecutive order in the direction of the exhaust gas: optionally an electric heater or a fuel burner and/or a fuel injector, a catalyst according to any of the embodiments disclosed herein, a selective catalytic reduction (SCR) catalyst, a selective catalytic reduction (SCR) catalyst, a catalyzed soot filter (CSF), a selective catalytic reduction (SCR) catalyst, and a selective catalytic reduction (SCR) catalyst.

According to a seventh alternative, it is preferred that the system comprises in consecutive order in the direction of the exhaust gas: optionally an electric heater or a fuel burner and/or a fuel injector, a catalyst according to any of the embodiments disclosed herein, a selective catalytic reduction (SCR) catalyst, a selective catalytic reduction (SCR) catalyst, a catalyzed soot filter (CSF), a selective catalytic reduction (SCR) catalyst, and an ammonia oxidation (AMOX) catalyst.

According to an eighth alternative, it is preferred that the system comprises in consecutive order in the direction of the exhaust gas: optionally an electric heater or a fuel burner and/or a fuel injector, a catalyst according to any of the embodiments disclosed herein, a selective catalytic reduction (SCR) catalyst, a selective catalytic reduction (SCR) catalyst, an optional fuel injector, a catalyst according to any of the embodiments disclosed herein, wherein the substrate is a wall-flow substrate, a selective catalytic reduction (SCR) catalyst, and an ammonia oxidation (AMOX) catalyst.

According to an ninth alternative, it is preferred that the system comprises in consecutive order in the direction of the exhaust gas: optionally an electric heater or a fuel burner and/or a fuel injector, a catalyst according to any of the embodiments disclosed herein, a selective catalytic reduction (SCR) catalyst, a selective catalytic reduction catalyst on filter (SCROF), and an ammonia oxidation (AMOX) catalyst.

According to an tenth alternative, it is preferred that the system comprises in consecutive order in the direction of the exhaust gas: optionally an electric heater or a fuel burner and/or a fuel injector, a selective catalytic reduction (SCR) catalyst, an optional fuel injector, a catalyst according to any of the embodiments disclosed herein, a selective catalytic reduction catalyst on filter (SCROF), and an ammonia oxidation (AMOX) catalyst.

According to an eleventh alternative, it is preferred that the system comprises in consecutive order in the direction of the exhaust gas: optionally an electric heater or a fuel burner and/or a fuel injector, a selective catalytic reduction (SCR) catalyst, an optional fuel injector, a catalyst according to any of the embodiments disclosed herein, a catalyzed soot filter (CSF), a selective catalytic reduction (SCR) catalyst, and an ammonia oxidation (AMOX) catalyst.

According to an twelfth alternative, it is preferred that the system comprises in consecutive order in the direction of the exhaust gas: optionally an electric heater or a fuel burner and/or a fuel injector, a selective catalytic reduction (SCR) catalyst, an optional fuel injector, a catalyst according to any of the embodiments disclosed herein, a catalyst according to any of the embodiments disclosed herein, wherein the substrate is a wall-flow substrate, a selective catalytic reduction (SCR) catalyst, and an ammonia oxidation (AMOX) catalyst.

According to a thirteenth alternative, it is preferred that the system comprises in consecutive order in the direction of the exhaust gas: optionally an electric heater or a fuel burner and/or a fuel injector, a catalyst according to any of the embodiments disclosed herein, a diesel particulate filter (DPF), a selective catalytic reduction (SCR) catalyst, a selective catalytic reduction (SCR) catalyst, a selective catalytic reduction (SCR) catalyst, a selective catalytic reduction (SCR) catalyst, and an ammonia oxidation (AMOX) catalyst.

According to a fourteenth alternative, it is preferred that the system comprises in consecutive order in the direction of the exhaust gas: optionally an electric heater or a fuel burner and/or a fuel injector, a catalyst according to any of the embodiments disclosed herein, a selective catalytic reduction catalyst on filter (SCROF), a selective catalytic reduction (SCR) catalyst, and an ammonia oxidation (AMOX) catalyst.

According to a fifteenth alternative, it is preferred that the system comprises in consecutive order in the direction of the exhaust gas: optionally an electric heater or a fuel burner and/or a fuel injector, a catalyst according to any of the embodiments disclosed herein, a selective catalytic reduction (SCR) catalyst, a selective catalytic reduction catalyst on filter (SCROF), a selective catalytic reduction (SCR) catalyst, and an ammonia oxidation (AMOX) catalyst.

Yet further, the present invention relates to a method for the treatment of an exhaust gas stream containing one or more of formaldehyde, nitrogen oxide (NO), and hydrocarbons, the method comprising
(A) providing an exhaust gas stream comprising one or more of formaldehyde, nitrogen oxide (NO), and hydrocarbons;
(B) directing the exhaust gas stream provided in (A) through a catalyst according to any one of the embodiments disclosed herein.

It is preferred that the exhaust gas stream provided in (A) comprises one or more sulfur-containing compounds, more preferably SO₂ and/or SO₃.

It is preferred that the exhaust gas stream provided in (A) comprises NOₓ.

It is preferred that the exhaust gas stream provided in (A) comprises CO.

It is preferred that the exhaust gas stream provided in (A) comprises formaldehyde.

It is preferred that the exhaust gas stream provided in (A) comprises nitrogen oxide (NO).

It is preferred that the exhaust gas stream provided in (A) comprises hydrocarbons, more preferably C1 to C20 hydrocarbons, more preferably C2 to C10 hydrocarbons.

Yet further, the present invention relates to use of a catalyst according to any one of the embodiments disclosed herein for the oxidation of one or more of formaldehyde, nitrogen oxide (NO), and hydrocarbons, more preferably for the oxidation of one or more of formaldehyde, nitrogen oxide (NO), and hydrocarbons in an exhaust gas stream, more preferably for the oxidation of one or more of formaldehyde, nitrogen oxide (NO), and hydrocarbons in the exhaust gas stream of an internal combustion engine, more preferably for the oxidation of one or more of formalde-hyde, nitrogen oxide (NO), and hydrocarbons in the exhaust gas stream of a compression ignition engine, more preferably for the oxidation of one or more of formaldehyde, nitrogen oxide (NO), and hydrocarbons in the exhaust gas stream of a diesel engine.

The present invention is further illustrated by the following set of embodiments and combinations of embodiments resulting from the dependencies and back-references as indicated. In particular, it is noted that in each instance where a range of embodiments is mentioned, for example in the context of a term such as “The catalyst of any one of embodiments 1 to 4”, every embodiment in this range is meant to be explicitly disclosed for the skilled person, i.e. the wording of this term is to be understood by the skilled person as being synonymous to “The catalyst of any one of embodiments 1, 2, 3, and 4”. Further, it is explicitly noted that the following set of embodiments represents a suitably structured part of the general description directed to preferred aspects of the present invention, and, thus, suitably supports, but does not represent the claims of the present invention.
1. A catalyst for the treatment of an exhaust gas stream containing one or more of formaldehyde, nitrogen oxide (NO), and hydrocarbons, the catalyst comprising
   a first washcoat layer comprising Mn and optionally comprising Ce, wherein Mn and optional Ce are respectively supported on a metal oxide,
   a second washcoat layer comprising Mn supported on an oxygen storage component, wherein the oxygen storage component comprises ceria, and
   a substrate,
wherein the substrate has an inlet end through which the exhaust gas stream may enter the catalyst, and an outlet end through which the exhaust gas stream may exit the catalyst,
wherein the catalyst further comprises one or more platinum group metals comprising Pt, Pd, or Pt and Pd, wherein the one or more platinum group metals are at least in part contained in one or more of:
   (a) the first washcoat layer,
   (b) the second washcoat layer, and
   (c) an optional third washcoat layer, or
   (d) optional third and fourth washcoat layers.
2. The catalyst of embodiment 1, wherein the first washcoat layer is substantially free of an oxygen storage component, wherein preferably the first washcoat layer is free of an oxygen storage component.
3. The catalyst of embodiment 1 or 2, wherein the loading of Mn, calculated as the element, in the first washcoat layer is in the range of from 1 to 50 wt.-% based on 100 wt.-% of the first washcoat layer, preferably from 2 to 30 wt.-%, more preferably from 5 to 20 wt.-%, more preferably from 8 to 12 wt.-%.
4. The catalyst of any of embodiments 1 to 3, wherein the first washcoat layer comprises Ce, wherein the loading of Ce, calculated as the element, in the first washcoat layer is in the range of from 1 to 50 wt.-% based on 100 wt.-% of the first washcoat layer, preferably from 2 to 30 wt.-%, more preferably from 5 to 20 wt.-%, more preferably from 8 to 12 wt. %.
5. The catalyst of any of embodiments 1 to 4, wherein the loading of Mn, calculated as the element, in the second washcoat layer is in the range of from 0.1 to 50 wt.-% based on 100 wt.-% of the second washcoat layer, preferably from 1 to 40 wt.-%, more preferably from 2 to 30 wt.-%, more preferably from 5 to 20 wt.-%, more preferably from 8 to 12 wt. %.
6. The catalyst of any of embodiments 1 to 5, wherein the first washcoat layer comprises Cu, wherein preferably Cu is supported on a metal oxide, wherein the first washcoat layer preferably comprises CuO, Cu₂O, or CuO and Cu₂O, more preferably CuO.
7. The catalyst of embodiment 6, wherein the loading of Cu, calculated as the element, in the first washcoat layer is in the range of from 1 to 50 wt.-% based on 100 wt.-% of the first washcoat layer, preferably from 2 to 30 wt.-%, more preferably from 5 to 20 wt.-%, more preferably from 8 to 12 wt.-%.
8. The catalyst of any of embodiments 1 to 7, wherein independently from one another, Mn is present in the form of one or more cations of Mn, wherein Mn is preferably contained in the first and/or second washcoat layer as one or more oxides, wherein Mn is preferably contained in the first and/or second washcoat layer as one or more oxides of Mn(II), Mn(III), Mn(II/III), and Mn(IV), more preferably as one or more oxides selected from the group consisting of MnO, Mn₂O₃, Mn₃O₄, MnO₂, Mn(O)OH, and Mn—Zr mixed oxides, including mixtures of two or more thereof, wherein the Mn—Zr mixed oxides are preferably contained in the first and/or second washcoat layer as a solid solution.
9. The catalyst of any of embodiments 1 to 8, wherein the metal oxide in the first washcoat layer onto which Mn and optional Ce and optional Cu are respectively supported is a particulate support material, wherein the particulate metal oxide support material is preferably selected from the group consisting of ZrO₂, Al₂O₃, SiO₂, TiO₂, La₂O₃-doped ZrO₂, ZrO₂-doped Al₂O₃, ZrO₂-doped SiO₂, SiO₂-doped Al₂O₃, CeO₂—ZrO₂ mixed oxide, CuO—Al₂O₃ mixed oxide, and mixtures of two or more thereof, more preferably from the group consisting of ZrO₂, La₂O₃-doped ZrO₂, ZrO₂-doped Al₂O₃, ZrO₂-doped SiO₂, TiO₂, and mixtures of two or more thereof, more preferably from the group consisting of ZrO₂, La₂O₃-doped ZrO₂, and mixtures thereof, wherein more preferably Mn and optional Ce and optional Cu are supported on particulate La₂O₃-doped ZrO₂, wherein preferably ZrO₂ is doped with La₂O₃ in an amount ranging from 1 to 50 wt. % based on 100 wt.-% of ZrO₂ and La₂O₃, preferably from 3 to 30 wt.-%, more preferably from 5 to 15 wt.-%, more preferably from 8 to 10 wt.-%.
10. The catalyst of embodiment 9, wherein the doped particulate metal oxide support materials preferably form a solid solution.
11. The catalyst of embodiment 9 or 10, wherein ZrO₂ is doped with La₂O₃ in an amount ranging from 1 to 50 wt. % and based on 100 wt.-% of ZrO₂ and La₂O₃, preferably from 3 to 30 wt.-%, more preferably from 5 to 15 wt.-%, more preferably from 8 to 10 wt.-%.
12. The catalyst of any of embodiments 1 to 11, wherein the loading of the oxygen storage component in the second washcoat layer is in the range of from 5 to 100 wt.-% based on 100 wt.-% of the second washcoat layer, preferably from 10 to 95 wt.-%, more preferably from 20 to 90 wt.-%, more preferably from 30 to 80 wt.-%, more preferably from 40 to 70 wt.-%.
13. The catalyst of any of embodiments 1 to 12, wherein the oxygen storage component comprises ceria and one or more further metal oxides selected from the group consisting of ZrO₂, La₂O₃, Y₂O₃, Nd₂O₃, Pr₂O₃, and Pr₆O₁₁, including mixtures of two or more thereof, wherein preferably, the oxygen storage component at least in part displays a fluorite structure, wherein more preferably, the oxygen storage component displays a fluorite structure.
14. The catalyst of any of embodiments 1 to 13, wherein the oxygen storage component comprises, preferably consists of, CeO₂—ZrO₂ mixed oxide, wherein CeO₂ and ZrO₂ preferably form a solid solution.
15. The catalyst of embodiment 13 or 14, wherein the oxygen storage component comprises rare earth metal-doped CeO₂—ZrO₂ mixed oxide,
   wherein the rare earth metal-doped CeO₂—ZrO₂ mixed oxide preferably comprises CeO₂ in an amount in the range of 10 to 95 wt.-%, more preferably in the range of 20 to 90 wt.-%, based on 100 wt.-% of the rare earth metal-doped CeO₂—ZrO₂ mixed oxide,
   wherein the CeO₂—ZrO₂ mixed oxide preferably comprises ZrO₂ in an amount in the range of 5 to 75 wt.-%, more preferably in the range of 9 to 70 wt.-%, based on 100 wt.-% of the rare earth metal-doped CeO₂—ZrO₂ mixed oxide,
   wherein the rare earth metal-doped CeO₂—ZrO₂ mixed oxide preferably comprises La₂O₃ as dopant, preferably in an amount in the range of 1 to 10 wt.-%, more preferably in an amount in the range of 1 to 5 wt.-%, more preferably in the range of 2 to 4 wt.-%, based on 100 wt.-% of the rare earth metal-doped CeO₂—ZrO₂ mixed oxide,
   wherein the rare earth metal-doped CeO₂—ZrO₂ mixed oxide preferably further comprises Y₂O₃ as dopant, preferably in an amount in the range of 1 to 10 wt.-%, more preferably in an amount in the range of 1 to 5 wt.-%, more preferably in the range of 2 to 4 wt.-%, based on 100 wt.-% of the rare earth metal-doped CeO₂—ZrO₂ mixed oxide,
   wherein the rare earth metal-doped CeO₂—ZrO₂ mixed oxide preferably further comprises Nd₂O₃ as dopant, preferably in an amount in the range of 1 to 10 wt.-%, more preferably in an amount in the range of 1 to 5 wt.-%, more preferably in the range of 2 to 4 wt.-%, based on 100 wt.-% of the rare earth metal-doped CeO₂—ZrO₂ mixed oxide,
   wherein the rare earth metal-doped CeO₂—ZrO₂ mixed oxide preferably further comprises praseodymium oxide, preferably Pr₂O₃, as dopant, preferably in an amount in the range of 1 to 10 wt.-%, more preferably in an amount in the range of 1 to 5 wt.-%, more preferably in the range of 2 to 4 wt.-%, based on 100 wt.-% of the rare earth metal-doped CeO₂—ZrO₂ mixed oxide.
16. The catalyst of embodiment 15, wherein the rare earth metal-doped CeO₂—ZrO₂ mixed oxide is doped with La₂O₃, preferably in an amount in the range of 1 to 20 wt.-%, more preferably in an amount in the range of 5 to 15 wt.-%, more preferably in the range of 9 to 11 wt.-%, based on 100 wt.-% of the rare earth metal-doped CeO₂—ZrO₂ mixed oxide.
17. The catalyst of any of embodiments 1 to 16, wherein independently from one another, the first and/or second washcoat layer further comprises one or more oxides selected from the group consisting of Al₂O₃, SiO₂, SiO₂-doped Al₂O₃, and mixtures of two or more thereof, wherein preferably the second washcoat layer further comprises Al₂O₃ and/or SiO₂-doped Al₂O₃, more preferably Al₂O₃.
18. The catalyst of any of embodiments 1 to 17, wherein the substrate is a wall-flow substrate or a flow-through substrate, preferably a honeycomb wall-flow substrate or a honeycomb flow-through substrate, more preferably a honeycomb flow-through substrate, wherein the flow-through substrate is more preferably a flow through substrate with high porosity walls.
19. The catalyst of any of embodiments 1 to 18, wherein the loading of the first washcoat layer is in the range of from 0.5 to 8 g/in³, preferably of from 0.8 to 7 g/in³, more preferably of from 0.9 to 6 g/in³, more preferably of from 1 to 5 g/in³, more preferably of from 1.5 to 3 g/in³, more preferably of from 1.8 to 2.5 g/in³.
20. The catalyst of any of embodiments 1 to 19, wherein the loading of the second washcoat layer is in the range of from 0.1 to 5 g/in³, preferably of from 0.3 to 3 g/in³, more preferably of from 0.4 to 2.5 g/in³, more preferably of from 0.5 to 2 g/in³, more preferably of from 0.8 to 1.2 g/in³.
21. The catalyst of any of embodiments 1 to 20, wherein the loading of the third washcoat layer is in the range of from 0.25 to 3.0 g/in³, preferably of from 0.5 to 2.5 g/in³, more preferably of from 1 to 2 g/in³.
22. The catalyst of any of embodiments 1 to 21, wherein the loading of the fourth washcoat layer is in the range of from 0.25 to 3.0 g/in³, preferably of from 0.5 to 2.5 g/in³, more preferably of from 1 to 2 g/in³.
23. The catalyst of any of embodiments 1 to 22, wherein the catalyst comprises one or more platinum group metals consisting of Pt, Pd, or Pt and Pd, wherein preferably the catalyst comprises Pt, or Pt and Pd as the one or more platinum group metals, wherein more preferably the catalyst comprises Pt and Pd as the one or more platinum group metals.
24. The catalyst of any of embodiments 1 to 23, wherein the catalyst comprises Pt, calculated as the element, at a loading in the range of from 2 to 250 g/ft³, preferably of from 5 to 150 g/ft³, more preferably of from 10 to 125 g/ft³, more preferably of from 20 to 100 g/ft³, more preferably of from 25 to 85 g/ft³, more preferably of from 30 to 80 g/ft³, more preferably of from 40 to 60 g/ft³.
25. The catalyst of any of embodiments 1 to 24, wherein the catalyst comprises Pd, calculated as the element, at a loading in the range of from 1 to 80 g/ft³, preferably of from 5 to 60 g/ft³, more preferably of from 10 to 50 g/ft³, more preferably of from 15 to 40 g/ft³, more preferably of from 20 to 30 g/ft³.
26. The catalyst of any of embodiments 1 to 25, wherein the catalyst comprises Pt and Pd, calculated as the respective element, at a total Pt and Pd loading in the range of from 2 to 250 g/ft³, preferably of from 5 to 200 g/ft³, more preferably of from 10 to 150 g/ft³, more preferably of from 20 to 130 g/ft³, more preferably of from 30 to 125 g/ft³, more preferably of from 40 to 110 g/ft³, more preferably of from 50 to 100 g/ft³, more preferably of from 60 to 90 g/ft³, more preferably of from 70 to 80 g/ft³.
27. The catalyst of any of embodiments 1 to 26, wherein the catalyst comprises Pt and Pd at a Pt: Pd weight ratio in the range of from 30:70 to 90:10, preferably of from 50:50 to 80:20, more preferably of from 60:40 to 75:25, more preferably of from 65:35 to 70:30.
28. The catalyst of any of embodiments 1 to 27, wherein the one or more platinum group metals are supported on a particulate support material, wherein the particulate support material is preferably selected from the group consisting of Al₂O₃, SiO₂, TiO₂, SiO₂-doped Al₂O₃, Mn oxide-doped Al₂O₃, and mixtures of two or more thereof, wherein preferably the one or more platinum group metals are supported on Al₂O₃ and/or SiO₂-doped Al₂O₃ and/or Mn oxide-doped Al₂O₃, more preferably SiO₂-doped Al₂O₃ or Al₂O₃ or Mn oxide-doped Al₂O₃, wherein the Mn oxide-doped Al₂O₃ preferably comprises from 1 to 10 weight-%, more preferably from 4 to 6 weight-%, of Mn oxide, calculated as MnO₂, based on 100 weight-% of the Mn oxide-doped Al₂O₃.
29. The catalyst of any of embodiments 1 to 28, wherein the first washcoat layer comprises a hydrocarbon trap material, wherein the hydrocarbon trap material comprises a molecular sieve, preferably a zeolite, more preferably a zeolite having a maximum pore size of 12-membered rings, more preferably zeolite beta, wherein the molecular sieve, preferably the zeolite, preferably comprises SiO₂ and Al₂O₃, wherein the molecular sieve, preferably the zeolite, more preferably has a molar ratio of SiO₂ to Al₂O₃ in the range of from 10:1 to 500:1, more preferably of from 10:1 to 100:1, more preferably of from 10:1 to 40:1, more preferably of from 15:1 to 30:1, more preferably of from 20:1 to 25:1, wherein the molecular sieve, preferably the zeolite, preferably comprises Fe, wherein the molecular sieve, preferably the zeolite, more preferably comprises Fe, calculated as Fe₂O₃, in an amount in the range of from 1.0 to 7.0 weight-%, more preferably of from 3.0 to 5.0 weight-%, more preferably of from 4.0 to 4.5 weight-%, based on the weight of the molecular sieve.
30. The catalyst of embodiment 29, wherein the loading of the hydrocarbon trap material in the first washcoat layer is in the range of from 0.01 to 2.0 g/in³, preferably in the range of from 0.05 to 1.0 g/in³, more preferably in the range of from 0.05 to 0.3 g/in³.
31. The catalyst of any of embodiments 1 to 30, wherein the second washcoat layer comprises a hydrocarbon trap material, wherein the hydrocarbon trap material comprises a molecular sieve, preferably a zeolite, more preferably a zeolite having a maximum pore size of 12-membered rings, more preferably zeolite beta, wherein the molecular sieve, preferably the zeolite, preferably comprises SiO₂ and Al₂O₃, wherein the molecular sieve, preferably the zeolite, more preferably has a molar ratio of SiO₂ to Al₂O₃ in the range of from 10:1 to 500:1, more preferably of from 10:1 to 100:1, more preferably of from 10:1 to 40:1, more preferably of from 15:1 to 30:1, more preferably of from 20:1 to 25:1, wherein the molecular sieve, preferably the zeolite, preferably comprises Fe, wherein the molecular sieve, preferably the zeolite, more preferably comprises Fe, calculated as Fe₂O₃, in an amount in the range of from 1.0 to 7.0 weight-%, more preferably of from 3.0 to 5.0 weight-%, more preferably of from 4.0 to 4.5 weight-%, based on the weight of the molecular sieve.
32. The catalyst of embodiment 31, wherein the loading of the hydrocarbon trap material in the second washcoat layer is in the range of from 0.01 to 2.0 g/in³, preferably in the range of from 0.05 to 1.0 g/in³, more preferably in the range of from 0.05 to 0.3 g/in³.
33. The catalyst of any of embodiments 1 to 32, wherein the catalyst comprises a third washcoat layer, wherein the one or more platinum group metals are at least in part contained in the third washcoat layer, wherein preferably the one or more platinum group metals are entirely contained in the third washcoat layer.
34. The catalyst of any of embodiments 1 to 33, wherein the third washcoat layer comprises a hydrocarbon trap material, wherein the hydrocarbon trap material comprises a molecular sieve, preferably a zeolite, more preferably a zeolite having a maximum pore size of 12-membered rings, more preferably zeolite beta, wherein the molecular sieve, preferably the zeolite, preferably comprises SiO₂ and Al₂O₃, wherein the molecular sieve, preferably the zeolite, more preferably has a molar ratio of SiO₂ to Al₂O₃ in the range of from 10:1 to 500:1, more preferably of from 10:1 to 100:1, more preferably of from 10:1 to 40:1, more preferably of from 15:1 to 30:1, more preferably of from 20:1 to 25:1, wherein the molecular sieve, preferably the zeolite, preferably comprises Fe, wherein the molecular sieve, preferably the zeolite, more preferably comprises Fe, calculated as Fe₂O₃, in an amount in the range of from 1.0 to 7.0 weight-%, more preferably of from 3.0 to 5.0 weight-%, more preferably of from 4.0 to 4.5 weight-%, based on the weight of the molecular sieve.
35. The catalyst of embodiment 34, wherein the loading of the hydrocarbon trap material in the third washcoat layer is in the range of from 0.01 to 2.0 g/in³, preferably in the range of from 0.05 to 1.0 g/in³, more preferably in the range of from 0.05 to 0.3 g/in³.
36. The catalyst of any of embodiments 1 to 35, wherein the catalyst displays a layered arrangement of the first and second washcoat layers, wherein the first washcoat layer is provided on the substrate, and wherein the second washcoat layer is provided on the first washcoat layer.
37. The catalyst of any of embodiments 1 to 35, wherein the catalyst displays a layered arrangement of the first and second washcoat layers, wherein the second washcoat layer is provided on the substrate, and wherein the first washcoat layer is provided on the second washcoat layer.
38. The catalyst of embodiment 36 or 37, wherein the one or more platinum group metals are at least in part contained in the second washcoat layer, wherein preferably the one or more platinum group metals are entirely contained in the second washcoat layer.
39. The catalyst of any of embodiments 36 to 38, wherein the one or more platinum group metals are at least in part contained in the first washcoat layer, wherein preferably the one or more platinum group metals are entirely contained in the first washcoat layer.
40. The catalyst of any of embodiments 1 to 35, wherein the catalyst comprises a third washcoat layer, wherein the catalyst displays a layered arrangement of the first, second, and third washcoat layers, wherein the first washcoat layer is provided on the substrate, the second washcoat layer is provided on the first washcoat layer, and the third washcoat layer is provided on the second washcoat layer.
41. The catalyst of embodiment 40, wherein the catalyst comprises a fourth washcoat layer, wherein the fourth washcoat layer is provided on the second layer, wherein the catalyst displays a zoned arrangement of the third and fourth washcoat layers, wherein the third washcoat layer is provided on the second washcoat layer along the axial length of the substrate starting from the inlet end of the substrate, and wherein the fourth washcoat layer is provided on the second washcoat layer along the axial length of the substrate starting from the outlet end of the substrate, wherein the length of the fourth washcoat layer is less than the axial length of the substrate such as to create an upstream zone comprising the third washcoat layer and a downstream zone comprising the fourth washcoat layer.
42. The catalyst of embodiment 40, wherein the catalyst comprises a fourth washcoat layer, wherein the fourth washcoat layer is provided on the second layer, wherein the catalyst displays a zoned arrangement of the third and fourth washcoat layers, wherein the fourth washcoat layer is provided on the second washcoat layer along the axial length of the substrate starting from the inlet end of the substrate, and wherein the third washcoat layer is provided on the second washcoat layer along the axial length of the substrate starting from the outlet end of the substrate, wherein the length of the fourth washcoat layer is less than the axial length of the substrate such as to create an upstream zone comprising the fourth washcoat layer and a downstream zone comprising the third washcoat layer.
43. The catalyst of embodiment 41 or 42, wherein the third and fourth washcoat layers are adjacent to one another.
44. The catalyst of any of embodiments 40 to 43, wherein the one or more platinum group metals are at least in part contained in the third washcoat layer and/or in the fourth washcoat layer, wherein preferably the one or more platinum group metals are entirely contained in the third and fourth washcoat layers.
45. The catalyst of any of embodiments 1 to 35, wherein the catalyst comprises a third washcoat layer, wherein the catalyst displays a layered arrangement of the first, second, and third washcoat layers, wherein the first washcoat layer is provided on the substrate, the third washcoat layer is provided on the first washcoat layer, and the second washcoat layer is provided on the third washcoat layer.
46. The catalyst of any of embodiments 1 to 35, wherein the catalyst comprises a third washcoat layer, wherein the catalyst displays a layered arrangement of the first, second, and third washcoat layers, wherein the second washcoat layer is provided on the substrate, the first washcoat layer is provided on the second washcoat layer, and the third washcoat layer is provided on the first washcoat layer.
47. The catalyst of embodiment 46, wherein the catalyst comprises a fourth washcoat layer, wherein the fourth washcoat layer is provided on the first layer, wherein the catalyst displays a zoned arrangement of the third and fourth washcoat layers, wherein the third washcoat layer is provided on the first washcoat layer along the axial length of the substrate starting from the inlet end of the substrate, and wherein the fourth washcoat layer is provided on the first washcoat layer along the axial length of the substrate starting from the outlet end of the substrate, wherein the length of the fourth washcoat layer is less than the axial length of the substrate such as to create an upstream zone comprising the third washcoat layer and a downstream zone comprising the fourth washcoat layer.
48. The catalyst of embodiment 46, wherein the catalyst comprises a fourth washcoat layer, wherein the fourth washcoat layer is provided on the first layer, wherein the catalyst displays a zoned arrangement of the third and fourth washcoat layers, wherein the fourth washcoat layer is provided on the first washcoat layer along the axial length of the substrate starting from the inlet end of the substrate, and wherein the third washcoat layer is provided on the first washcoat layer along the axial length of the substrate starting from the outlet end of the substrate, wherein the length of the fourth washcoat layer is less than the axial length of the substrate such as to create an upstream zone comprising the fourth washcoat layer and a downstream zone comprising the third washcoat layer.
49. The catalyst of embodiment 47 or 48, wherein the third and fourth washcoat layers are adjacent to one another.
50. The catalyst of any of embodiments 46 to 49, wherein the one or more platinum group metals are at least in part contained in the third washcoat layer and/or in the fourth washcoat layer, wherein preferably the one or more platinum group metals are entirely contained in the third and fourth washcoat layers.
51. The catalyst of any of embodiments 1 to 35, wherein the catalyst comprises a third washcoat layer, wherein the catalyst displays a layered arrangement of the first, second, and third washcoat layers, wherein the second washcoat layer is provided on the substrate, the third washcoat layer is provided on the second washcoat layer, and the first washcoat layer is provided on the third washcoat layer.
52. The catalyst of any of embodiments 45 to 51, wherein the one or more platinum group metals are at least in part contained in the third washcoat layer, wherein preferably the one or more platinum group metals are entirely contained in the third washcoat layer.
53. The catalyst of any of embodiments 1 to 35, wherein the catalyst displays a zoned arrangement of the first and second washcoat layers, wherein the second washcoat layer is provided on the substrate along its axial length starting from the inlet end of the substrate, and wherein the first washcoat layer is provided on the substrate along its axial length starting from the outlet end of the substrate, wherein the length of the first washcoat layer is less than the axial length of the substrate such as to create an upstream zone comprising the second washcoat layer and a downstream zone comprising the first washcoat layer.
54. The catalyst of any of embodiments 1 to 35, wherein the catalyst displays a zoned arrangement of the first and second washcoat layers, wherein the second washcoat layer is provided on the substrate along its axial length starting from the outlet end of the substrate, and wherein the first washcoat layer is provided on the substrate along its axial length starting from the inlet end of the substrate, wherein the length of the first washcoat layer is less than the axial length of the substrate such as to create an upstream zone comprising the first washcoat layer and a downstream zone comprising the second washcoat layer.
55. The catalyst of any of embodiments 1 to 35, wherein the catalyst displays a zoned arrangement of the first and second washcoat layers, wherein the second washcoat layer is provided on the substrate along its axial length starting from the inlet end of the substrate, and wherein the first washcoat layer is provided on the substrate along its axial length starting from the outlet end of the substrate, wherein the length of the second washcoat layer is less than the axial length of the substrate such as to create an upstream zone comprising the second washcoat layer and a downstream zone comprising the first washcoat layer.
56. The catalyst of any of embodiments 1 to 35, wherein the catalyst displays a zoned arrangement of the first and second washcoat layers, wherein the second washcoat layer is provided on the substrate along its axial length starting from the outlet end of the substrate, and wherein the first washcoat layer is provided on the substrate along its axial length starting from the inlet end of the substrate, wherein the length of the second washcoat layer is less than the axial length of the substrate such as to create an upstream zone comprising the first washcoat layer and a downstream zone comprising the second washcoat layer.
57. The catalyst of any of embodiments 53 to 56, wherein the one or more platinum group metals are at least in part contained in the second washcoat layer, wherein preferably the one or more platinum group metals are entirely contained in the second washcoat layer.
58. The catalyst of embodiment 53 to 57, wherein the one or more platinum group metals are at least in part contained in the first washcoat layer, wherein preferably the one or more platinum group metals are entirely contained in the first washcoat layer.
59. The catalyst of any of embodiments 53 to 58, wherein the first and second washcoat layers are adjacent to one another.
60. The catalyst of any of embodiments 53 to 58, wherein a portion of the second washcoat layer overlaps at least a portion of the first washcoat layer, wherein preferably the second washcoat layer overlaps the first washcoat layer over a portion ranging from 5 to 100% of the axial length of the substrate, preferably from 10 to 100% of the axial length of the first washcoat layer, more preferably from 15 to 80%, and more preferably from 20 to 50%.
61. The catalyst of any of embodiments 53 to 58, wherein a portion of the first washcoat layer overlaps at least a portion of the second washcoat layer, wherein preferably the first washcoat layer overlaps the second washcoat layer over a portion ranging from 5 to 100% of the axial length of the substrate, preferably from 10 to 100% of the axial length of the second washcoat layer, more preferably from 15 to 80%, and more preferably from 20 to 50%.
62. The catalyst of any of embodiments 1 to 35, wherein the catalyst comprises a third washcoat layer, wherein the catalyst displays a zoned arrangement of the first, second, and third washcoat layers, wherein the third washcoat layer is provided on the substrate along its axial length starting from the inlet end of the substrate and wherein the first washcoat layer is provided on the substrate along its axial length starting from the outlet end of the substrate, and wherein the second washcoat layer is provided on the first washcoat layer from the outlet end of the substrate, wherein the length of the first washcoat layer is less than the axial length of the substrate such a to create an upstream zone comprising the third washcoat layer and a downstream zone comprising the first and second washcoat layers, and wherein the one or more platinum group metals are at least in part contained in the third washcoat layer.
63. The catalyst of embodiment 62, wherein the first and third washcoat layers are adjacent to one another.
64. The catalyst of embodiment 62 or 63, wherein the second and third washcoat layers are adjacent to one another.
65. The catalyst of embodiment 62 or 63, wherein a portion of the second washcoat layer overlaps at least a portion of the third washcoat layer, wherein preferably the second washcoat layer overlaps the third washcoat layer over a portion ranging from 5 to 100% of the axial length of the substrate, preferably from 10 to 100% of the axial length of the third washcoat layer, more preferably from 15 to 80%, and more preferably from 20 to 50%.
66. The catalyst of any of embodiments 62 to 65, wherein the catalyst comprises a fourth washcoat layer, wherein the fourth washcoat layer is provided on the second layer, wherein the catalyst displays a zoned arrangement of the third and fourth washcoat layers, wherein the third washcoat layer is at least partially provided on the substrate along the axial length of the substrate starting from the inlet end of the substrate, and wherein the fourth washcoat layer is provided on the second washcoat layer along the axial length of the substrate starting from the outlet end of the substrate, wherein the length of the fourth washcoat layer is less than the axial length of the substrate such as to create an upstream zone comprising the third washcoat layer and a downstream zone comprising the first, second and fourth washcoat layers.
67. The catalyst of any of embodiments 1 to 35, wherein the catalyst comprises a third washcoat layer, wherein the catalyst displays a zoned arrangement of the first, second, and third washcoat layers, wherein the third washcoat layer is provided on the substrate along its axial length starting from the inlet end of the substrate and wherein the second washcoat layer is provided on the substrate along its axial length starting from the outlet end of the substrate, and wherein the first washcoat layer is provided on the second washcoat layer from the outlet end of the substrate, wherein the length of the second washcoat layer is less than the axial length of the substrate such a to create an upstream zone comprising the third washcoat layer and a downstream zone comprising the first and second washcoat layers, and wherein the one or more platinum group metals are at least in part contained in the third washcoat layer.
68. The catalyst of embodiment 67, wherein the second and third washcoat layers are adjacent to one another.
69. The catalyst of embodiment 67 or 68, wherein the first and third washcoat layers are adjacent to one another.
70. The catalyst of embodiment 67 or 68, wherein a portion of the first washcoat layer overlaps at least a portion of the third washcoat layer, wherein preferably the first washcoat layer overlaps the third washcoat layer over a portion ranging from 5 to 100% of the axial length of the substrate, preferably from 10 to 100% of the axial length of the third washcoat layer, more preferably from 15 to 80%, and more preferably from 20 to 50%.
71. The catalyst of any of embodiments 67 to 70, wherein the catalyst comprises a fourth washcoat layer, wherein the fourth washcoat layer is provided on the first layer, wherein the catalyst displays a zoned arrangement of the third and fourth washcoat layers, wherein the third washcoat layer is at least partially provided on the substrate along the axial length of the substrate starting from the inlet end of the substrate, and wherein the fourth washcoat layer is provided on the first washcoat layer along the axial length of the substrate starting from the outlet end of the substrate, wherein the length of the fourth washcoat layer is less than the axial length of the substrate such as to create an upstream zone comprising the third washcoat layer and a downstream zone comprising the first, second and fourth washcoat layers.
72. The catalyst of any of embodiments 1 to 35, wherein the catalyst comprises a third washcoat layer, wherein the catalyst displays a zoned arrangement of the first, second, and third washcoat layers, wherein the third washcoat layer is provided on the substrate along its axial length starting from the outlet end of the substrate and wherein the first washcoat layer is provided on the substrate along its axial length starting from the inlet end of the substrate, and wherein the second washcoat layer is provided on the first washcoat layer from the inlet end of the substrate, wherein the length of the first washcoat layer is less than the axial length of the substrate such a to create a downstream zone comprising the third washcoat layer and an upstream zone comprising the first and second washcoat layers, and wherein the one or more platinum group metals are at least in part contained in the third washcoat layer.
73. The catalyst of embodiment 72, wherein the first and third washcoat layers are adjacent to one another.
74. The catalyst of embodiment 72 or 73, wherein the second and third washcoat layers are adjacent to one another.
75. The catalyst of embodiment 72 or 73, wherein a portion of the second washcoat layer overlaps at least a portion of the third washcoat layer, wherein preferably the second washcoat layer overlaps the third washcoat layer over a portion ranging from 5 to 100% of the axial length of the substrate, preferably from 10 to 100% of the axial length of the third washcoat layer, more preferably from 15 to 80%, and more preferably from 20 to 50%.
76. The catalyst of any of embodiments 72 to 75, wherein the catalyst comprises a fourth washcoat layer, wherein the fourth washcoat layer is provided on the second layer, wherein the catalyst displays a zoned arrangement of the third and fourth washcoat layers, wherein the third washcoat layer is at least partially provided on the substrate along the axial length of the substrate starting from the outlet end of the substrate, and wherein the fourth washcoat layer is provided on the second washcoat layer along the axial length of the substrate starting from the inlet end of the substrate, wherein the length of the fourth washcoat layer is less than the axial length of the substrate such as to create an upstream zone comprising the first, second and fourth washcoat layers and a downstream zone comprising the third washcoat layer.
77. The catalyst of any of embodiments 1 to 35, wherein the catalyst comprises a third washcoat layer, wherein the catalyst displays a zoned arrangement of the first, second, and third washcoat layers, wherein the third washcoat layer is provided on the substrate along its axial length starting from the outlet end of the substrate and wherein the second washcoat layer is provided on the substrate along its axial length starting from the inlet end of the substrate, and wherein the first washcoat layer is provided on the second washcoat layer from the inlet end of the substrate, wherein the length of the second washcoat layer is less than the axial length of the substrate such a to create a downstream zone comprising the third washcoat layer and an upstream zone comprising the first and second washcoat layers, and wherein the one or more platinum group metals are at least in part contained in the third washcoat layer.
78. The catalyst of embodiment 77, wherein the second and third washcoat layers are adjacent to one another.
79. The catalyst of embodiment 77 or 78, wherein the first and third washcoat layers are adjacent to one another.
80. The catalyst of embodiment 77 or 79, wherein a portion of the first washcoat layer overlaps at least a portion of the third washcoat layer, wherein preferably the first washcoat layer overlaps the third washcoat layer over a portion ranging from 5 to 100% of the axial length of the substrate, preferably from 10 to 100% of the axial length of the third washcoat layer, more preferably from 15 to 80%, and more preferably from 20 to 50%.
81. The catalyst of any of embodiments 77 to 80, wherein the catalyst comprises a fourth washcoat layer, wherein the fourth washcoat layer is provided on the first layer, wherein the catalyst displays a zoned arrangement of the third and fourth washcoat layers, wherein the third washcoat layer is at least partially provided on the substrate along the axial length of the substrate starting from the outlet end of the substrate, and wherein the fourth washcoat layer is provided on the first washcoat layer along the axial length of the substrate starting from the inlet end of the substrate, wherein the length of the fourth washcoat layer is less than the axial length of the substrate such as to create an upstream zone comprising the first, second and fourth washcoat layers and a downstream zone comprising the third washcoat layer.
82. The catalyst of any of embodiments 62 to 65, wherein a portion of the third washcoat layer overlaps at least a portion of the second washcoat layer, wherein preferably the third washcoat layer overlaps the second washcoat layer over a portion ranging from 10 to 100% of the axial length of the second washcoat layer, more preferably from 15 to 80%, and more preferably from 20 to 50%.
83. The catalyst of embodiment 82, wherein the catalyst comprises a fourth washcoat layer, wherein the fourth washcoat layer is provided on the second layer, wherein the catalyst displays a zoned arrangement of the third and fourth washcoat layers, wherein the third washcoat layer is at least partially provided on the substrate along the axial length of the substrate starting from the inlet end of the substrate, and wherein the fourth washcoat layer is provided on the second washcoat layer along the axial length of the substrate starting from the outlet end of the substrate, wherein the length of the fourth washcoat layer is less than the axial length of the substrate such as to create an upstream zone comprising the third washcoat layer and a downstream zone comprising the fourth washcoat layer.
84. The catalyst of any of embodiments 72 to 75, wherein a portion of the third washcoat layer overlaps at least a portion of the second washcoat layer, wherein preferably the third washcoat layer overlaps the second washcoat layer over a portion ranging from 10 to 100% of the axial length of the second washcoat layer, more preferably from 15 to 80%, and more preferably from 20 to 50%.
85. The catalyst of embodiment 84, wherein the catalyst comprises a fourth washcoat layer, wherein the fourth washcoat layer is provided on the second layer, wherein the catalyst displays a zoned arrangement of the third and fourth washcoat layers, wherein the third washcoat layer is at least partially provided on the substrate along the axial length of the substrate starting from the outlet end of the substrate, and wherein the fourth washcoat layer is provided on the second washcoat layer along the axial length of the substrate starting from the inlet end of the substrate, wherein the length of the fourth washcoat layer is less than the axial length of the substrate such as to create an upstream zone comprising the fourth washcoat layer and a downstream zone comprising the third washcoat layer.
86. The catalyst of any of embodiments 67 to 70, wherein a portion of the third washcoat layer overlaps at least a portion of the first washcoat layer, wherein preferably the third washcoat layer overlaps the first washcoat layer over a portion ranging from 10 to 100% of the axial length of the first washcoat layer, more preferably from 15 to 80%, and more preferably from 20 to 50%.
87. The catalyst of embodiment 86, wherein the catalyst comprises a fourth washcoat layer, wherein the fourth washcoat layer is provided on the first layer, wherein the catalyst displays a zoned arrangement of the third and fourth washcoat layers, wherein the third washcoat layer is at least partially provided on the substrate along the axial length of the substrate starting from the inlet end of the substrate, and wherein the fourth washcoat layer is provided on the first washcoat layer along the axial length of the substrate starting from the outlet end of the substrate, wherein the length of the fourth washcoat layer is less than the axial length of the substrate such as to create an upstream zone comprising the third washcoat layer and a downstream zone comprising the fourth washcoat layer.
88. The catalyst of any of embodiments 77 to 80, wherein a portion of the third washcoat layer overlaps at least a portion of the first washcoat layer, wherein preferably the third washcoat layer overlaps the first washcoat layer over a portion ranging from 10 to 100% of the axial length of the first washcoat layer, more preferably from 15 to 80%, and more preferably from 20 to 50%.
89. The catalyst of embodiment 88, wherein the catalyst comprises a fourth washcoat layer, wherein the fourth washcoat layer is provided on the second layer, wherein the catalyst displays a zoned arrangement of the third and fourth washcoat layers, wherein the third washcoat layer is at least partially provided on the substrate along the axial length of the substrate starting from the outlet end of the substrate, and wherein the fourth washcoat layer is provided on the first washcoat layer along the axial length of the substrate starting from the inlet end of the substrate, wherein the length of the fourth washcoat layer is less than the axial length of the substrate such as to create an upstream zone comprising the fourth washcoat layer and a downstream zone comprising the third washcoat layer.
90. The catalyst of any of embodiments 1 to 89, wherein the third and fourth washcoat layers are adjacent to one another.
91. The catalyst of any of embodiments 36 to 90, wherein the length of the first washcoat layer ranges from 5 to 100% of the axial length of the substrate, preferably from 10 to 90% of the axial length of the substrate, more preferably from 30 to 80%, more preferably from 45 to 75%, and more preferably from 50 to 70%.
92. The catalyst of any of embodiments 36 to 91, wherein the length of the second washcoat layer ranges from 5 to 100% of the axial length of the substrate, preferably from 10 to 90% of the axial length of the substrate, more preferably from 30 to 80%, more preferably from 45 to 75%, and more preferably from 50 to 70%.
93. The catalyst of any of embodiments 1 to 92, wherein the one or more platinum group metals are entirely contained in the third washcoat layer or in the third and fourth washcoat layers.
94. The catalyst of any of embodiments 1 to 93, wherein the length of the third washcoat layer ranges from 5 to 100% of the axial length of the substrate, preferably from 10 to 90% of the axial length of the substrate, more preferably from 20 to 60%, and more preferably from 35 to 45%.
95. The catalyst of any of embodiments 1 to 94, wherein the catalyst comprises the fourth washcoat layer, wherein the length of the fourth washcoat layer ranges from 5 to 100% of the axial length of the substrate, preferably from 10 to 90% of the axial length of the substrate, more preferably from 20 to 60%, and more preferably from 35 to 45%.
96. The catalyst of any of embodiments 1 to 95, wherein the fourth washcoat layer comprises a hydrocarbon trap material, wherein the hydrocarbon trap material comprises a molecular sieve, preferably a zeolite, more preferably a zeolite having a maximum pore size of 12-membered rings, more preferably zeolite beta, wherein the molecular sieve, preferably the zeolite, preferably comprises SiO₂ and Al₂O₃, wherein the molecular sieve, preferably the zeolite, more preferably has a molar ratio of SiO₂ to Al₂O₃ in the range of from 10:1 to 500:1, more preferably of from 10:1 to 100:1, more preferably of from 10:1 to 40:1, more preferably of from 15:1 to 30:1, more preferably of from 20:1 to 25:1, wherein the molecular sieve, preferably the zeolite, preferably comprises Fe, wherein the molecular sieve, preferably the zeolite, more preferably comprises Fe, calculated as Fe₂O₃, in an amount in the range of from 1.0 to 7.0 weight-%, more preferably of from 3.0 to 5.0 weight-%, more preferably of from 4.0 to 4.5 weight-%, based on the weight of the molecular sieve.
97. The catalyst of embodiment 96, wherein the loading of the hydrocarbon trap material in the fourth washcoat layer is in the range of from 0.01 to 2.0 g/in³, preferably in the range of from 0.05 to 1.0 g/in³, more preferably in the range of from 0.05 to 0.3 g/in³.
98. The catalyst of any of embodiments 1 to 97, wherein the one or more platinum group metals are at least in part contained in the fourth washcoat layer.
99. The catalyst of embodiment 98, wherein the one or more platinum group metals are supported on a particulate support material, wherein the particulate support material is preferably selected from the group consisting of Al₂O₃, SiO₂, TiO₂, SiO₂-doped Al₂O₃, Mn oxide-doped Al₂O₃, and mixtures of two or more thereof, wherein preferably the one or more platinum group metals are supported on Al₂O₃ and/or SiO₂-doped Al₂O₃ and/or Mn oxide-doped Al₂O₃, more preferably SiO₂-doped Al₂O₃ or Al₂O₃ or Mn oxide-doped Al₂O₃, wherein the Mn oxide-doped Al₂O₃ preferably comprises from 1 to 10 weight-%, more preferably from 4 to 6 weight-%, of Mn oxide, calculated as MnO₂, based on 100 weight-% of the Mn oxide-doped Al₂O₃.
100. The catalyst of any of embodiments 1 to 99, wherein the catalyst comprises third and fourth washcoat layers, wherein the one or more platinum group metals are entirely contained in the third and fourth washcoat layers, wherein the weight ratio of the one or more platinum group metals comprised in the third washcoat layer to the one or more platinum group metals comprised in the fourth washcoat layer is in the range of from 0.5:1 to 5.0:1, more preferably 1.0:1 to 2.0:1, more preferably in the range of from 1.4:1 to 1.6:1, wherein the one or more platinum group metals comprised in the third washcoat layer preferably comprise, more preferably consist of, Pt and Pd, wherein the one or more platinum group metals comprised in the fourth washcoat layer preferably comprise, more preferably consist of, Pt and Pd.
101. The catalyst of any of embodiments 1 to 100, wherein the one or more platinum group metals are entirely contained in the third washcoat layer and/or in the optional fourth washcoat layer.
102. The catalyst of any of embodiments 1 to 101, wherein the substrate is a metallic substrate or a ceramic substrate, wherein preferably the substrate is a ceramic substrate, wherein more preferably the substrate comprises cordierite and/or SIC, preferably cordierite, wherein more preferably, the substrate consists cordierite and/or SIC, preferably of cordierite.
103. The catalyst of any of embodiments 45 to 102, wherein the substrate consists of two separate monoliths, wherein the first monolith is provided upstream of the second monolith, wherein the washcoat layer or washcoat layers of the upstream zone are contained on the first monolith, and the washcoat layer or washcoat layers of the downstream zone are contained on the second monolith, wherein preferably the first monolith containing the washcoat layer or washcoat layers of the upstream zone and the second monolith containing the washcoat layer or washcoat layers of the downstream zone are obtained or obtainable by sectioning of a catalyst according to any of embodiments 40 to 69 into two separate monoliths, wherein the washcoat layer or washcoat layers of the upstream zone are contained on the first monolith, and the washcoat layer or washcoat layers of the downstream zone are contained on the second monolith.
104. The catalyst of any of embodiments 1 to 103, wherein the exhaust gas stream contains hydrocarbons, preferably C1 to C20 hydrocarbons, more preferably C2 to C10 hydrocarbons.
105. Exhaust gas treatment system comprising an internal combustion engine and an exhaust gas conduit for exhaust gas from the internal combustion engine, wherein the exhaust gas conduit comprises one or more catalysts according to any of embodiments 1 to 104, preferably one, two, three, or four catalysts according to any of embodiments 1 to 104.
106. The exhaust gas treatment system of embodiment 105, wherein the internal combustion engine is a compression ignition engine, preferably a diesel engine.
107. The exhaust gas treatment system of embodiment 105 or 106, wherein the internal combustion engine is a lean gasoline engine.
108. The exhaust gas treatment system of embodiment 75, wherein the internal combustion engine is powered by an oxygenated fuel, wherein the oxygenated fuel preferably comprises one or more of methanol and biofuel.
109. The exhaust gas treatment system of any of embodiments 75 to 108, wherein the system comprises one or more of an electric heater, a fuel burner, a fuel injector, a selective catalytic reduction (SCR) catalyst, an ammonia oxidation (AMOX) catalyst, a catalyzed soot filter (CSF), a diesel particulate filter (DPF), a selective catalytic reduction catalyst on filter (SCROF), and a diesel exotherm catalyst (DEC).
110. The exhaust gas treatment system of embodiment 109, comprising in consecutive order in the direction of the exhaust gas: optionally an electric heater or a fuel burner and/or a fuel injector, a catalyst according to any of embodiments 1 to 104, a catalyst according to any of embodiments 1 to 104, a selective catalytic reduction (SCR) catalyst, a selective catalytic reduction (SCR) catalyst, an optional fuel injector, a diesel exotherm catalyst (DEC), a catalyzed soot filter (CSF), a selective catalytic reduction (SCR) catalyst, and a selective catalytic reduction (SCR) catalyst.
111. The exhaust gas treatment system of embodiment 109, comprising in consecutive order in the direction of the exhaust gas: optionally an electric heater or a fuel burner and/or a fuel injector, a catalyst according to any of embodiments 1 to 104, a catalyst according to any of embodiments 1 to 104, a selective catalytic reduction (SCR) catalyst, a selective catalytic reduction (SCR) catalyst, an optional fuel injector, a diesel exotherm catalyst (DEC), a diesel particulate filter (DPF), a selective catalytic reduction (SCR) catalyst, and a selective catalytic reduction (SCR) catalyst.
112. The exhaust gas treatment system of embodiment 109, comprising in consecutive order in the direction of the exhaust gas: optionally an electric heater or a fuel burner and/or a fuel injector, a catalyst according to any of embodiments 1 to 104, a catalyst according to any of embodiments 1 to 104, a selective catalytic reduction (SCR) catalyst, a selective catalytic reduction (SCR) catalyst, an optional fuel injector, a diesel exotherm catalyst (DEC), a diesel particulate filter (DPF), a selective catalytic reduction (SCR) catalyst, and an ammonia oxidation (AMOX) catalyst.
113. The exhaust gas treatment system of embodiment 109, comprising in consecutive order in the direction of the exhaust gas: optionally an electric heater or a fuel burner and/or a fuel injector, a catalyst according to any of embodiments 1 to 104, a catalyst according to any of embodiments 1 to 104, a selective catalytic reduction (SCR) catalyst, a selective catalytic reduction (SCR) catalyst, an optional fuel injector, a catalyst according to any of embodiments 1 to 104, a diesel particulate filter (DPF), a selective catalytic reduction (SCR) catalyst, and a selective catalytic reduction (SCR) catalyst.
114. The exhaust gas treatment system of embodiment 109, comprising in consecutive order in the direction of the exhaust gas: optionally an electric heater or a fuel burner and/or a fuel injector, a catalyst according to any of embodiments 1 to 7104 a catalyst according to any of embodiments 1 to 104, a selective catalytic reduction (SCR) catalyst, a selective catalytic reduction (SCR) catalyst, an optional fuel injector, a catalyst according to any of embodiments 1 to 104, a catalyst according to any of embodiments 1 to 104, wherein the substrate is a wall-flow substrate, a selective catalytic reduction (SCR) catalyst, and an ammonia oxidation (AMOX) catalyst.
115. The exhaust gas treatment system of embodiment 109, comprising in consecutive order in the direction of the exhaust gas: optionally an electric heater or a fuel burner and/or a fuel injector, a catalyst according to any of embodiments 1 to 104, a selective catalytic reduction (SCR) catalyst, a selective catalytic reduction (SCR) catalyst, a catalyzed soot filter (CSF), a selective catalytic reduction (SCR) catalyst, and a selective catalytic reduction (SCR) catalyst.
116. The exhaust gas treatment system of embodiment 109, comprising in consecutive order in the direction of the exhaust gas: optionally an electric heater or a fuel burner and/or a fuel injector, a catalyst according to any of embodiments 1 to 104, a selective catalytic reduction (SCR) catalyst, a selective catalytic reduction (SCR) catalyst, a catalyzed soot filter (CSF), a selective catalytic reduction (SCR) catalyst, and an ammonia oxidation (AMOX) catalyst.
117. The exhaust gas treatment system of embodiment 109, comprising in consecutive order in the direction of the exhaust gas: optionally an electric heater or a fuel burner and/or a fuel injector, a catalyst according to any of embodiments 1 to 104, a selective catalytic reduction (SCR) catalyst, a selective catalytic reduction (SCR) catalyst, an optional fuel injector, a catalyst according to any of embodiments 1 to 104, wherein the substrate is a wall-flow substrate, a selective catalytic reduction (SCR) catalyst, and an ammonia oxidation (AMOX) catalyst.
118. The exhaust gas treatment system of embodiment 109, comprising in consecutive order in the direction of the exhaust gas: optionally an electric heater or a fuel burner and/or a fuel injector, a catalyst according to any of embodiments 1 to 104, a selective catalytic reduction (SCR) catalyst, a selective catalytic reduction catalyst on filter (SCROF), and an ammonia oxidation (AMOX) catalyst.
119. The exhaust gas treatment system of embodiment 109, comprising in consecutive order in the direction of the exhaust gas: optionally an electric heater or a fuel burner and/or a fuel injector, a selective catalytic reduction (SCR) catalyst, an optional fuel injector, a catalyst according to any of embodiments 1 to 104, a selective catalytic reduction catalyst on filter (SCROF), and an ammonia oxidation (AMOX) catalyst.
120. The exhaust gas treatment system of embodiment 109, comprising in consecutive order in the direction of the exhaust gas: optionally an electric heater or a fuel burner and/or a fuel injector, a selective catalytic reduction (SCR) catalyst, an optional fuel injector, a catalyst according to any of embodiments 1 to 104, a catalyzed soot filter (CSF), a selective catalytic reduction (SCR) catalyst, and an ammonia oxidation (AMOX) catalyst.
121. The exhaust gas treatment system of embodiment 109, comprising in consecutive order in the direction of the exhaust gas: optionally an electric heater or a fuel burner and/or a fuel injector, a selective catalytic reduction (SCR) catalyst, an optional fuel injector, a catalyst according to any of embodiments 1 to 104, a catalyst according to any of embodiments 1 to 104, wherein the substrate is a wall-flow substrate, a selective catalytic reduction (SCR) catalyst, and an ammonia oxidation (AMOX) catalyst.
122. The exhaust gas treatment system of embodiment 109, comprising in consecutive order in the direction of the exhaust gas: optionally an electric heater or a fuel burner and/or a fuel injector, a catalyst according to any of embodiments 1 to 104, a diesel particulate filter (DPF), a selective catalytic reduction (SCR) catalyst, a selective catalytic reduction (SCR) catalyst, a selective catalytic reduction (SCR) catalyst, a selective catalytic reduction (SCR) catalyst, and an ammonia oxidation (AMOX) catalyst.
123. The exhaust gas treatment system of embodiment 109, comprising in consecutive order in the direction of the exhaust gas: optionally an electric heater or a fuel burner and/or a fuel injector, a catalyst according to any of embodiments 1 to 104, a selective catalytic reduction catalyst on filter (SCROF), a selective catalytic reduction (SCR) catalyst, and an ammonia oxidation (AMOX) catalyst.
124. The exhaust gas treatment system of embodiment 109, comprising in consecutive order in the direction of the exhaust gas: optionally an electric heater or a fuel burner and/or a fuel injector, a catalyst according to any of embodiments 1 to 104, a selective catalytic reduction (SCR) catalyst, a selective catalytic reduction catalyst on filter (SCROF), a selective catalytic reduction (SCR) catalyst, and an ammonia oxidation (AMOX) catalyst.
125. Method for the treatment of an exhaust gas stream containing one or more of formaldehyde, nitrogen oxide (NO), and hydrocarbons, the method comprising
   (A) providing an exhaust gas stream comprising one or more of formaldehyde, nitrogen oxide (NO), and hydrocarbons;
   (B) directing the exhaust gas stream provided in (A) through a catalyst according to any of embodiments 1 to 104.
126. The method of embodiment 125, wherein the exhaust gas stream provided in (A) comprises one or more sulfur-containing compounds, preferably SO₂ and/or SO₃.
127. The method of embodiment 125 or 126, wherein the exhaust gas stream provided in (A) comprises NOₓ.
128. The method of any of embodiments 125 to 127, wherein the exhaust gas stream provided in (A) comprises CO.
129. The method of any of embodiments 125 to 128, wherein the exhaust gas stream provided in (A) comprises hydrocarbons, preferably C1 to C20 hydrocarbons, more preferably C2 to C10 hydrocarbons.
130. Use of a catalyst according to any of embodiments 1 to 104 for the oxidation of one or more of formaldehyde, nitrogen oxide (NO), and hydrocarbons, preferably for the oxidation of one or more of formaldehyde, nitrogen oxide (NO), and hydrocarbons in an exhaust gas stream, more preferably for the oxidation of one or more of formaldehyde, nitrogen oxide (NO), and hydrocarbons in the exhaust gas stream of an internal combustion engine, more preferably for the oxidation of one or more of formaldehyde, nitrogen oxide (NO), and hydrocarbons in the exhaust gas stream of a compression ignition engine, more preferably for the oxidation of one or more of formaldehyde, nitrogen oxide (NO), and hydrocarbons in the exhaust gas stream of a diesel engine.

The present invention is further illustrated by the following examples and comparative examples.

### EXPERIMENTAL SECTION

### Comparative Example 1A: Preparation of a Catalyst for the Treatment of an Exhaust Gas Stream Containing One or More of Formaldehyde, Nitrogen Oxide (NO), and Hydrocarbons

A catalyst was prepared by coating platinum group metal (PGM)-containing front zone and base metal oxide (BMO)-containing rear zone segments separately on 1″ diameter cordierite honeycomb substrates and then combining the coated cores sequentially for subsequent S aging and testing. The front zone segment was prepared by first combining Pt, Pd, Beta zeolite and a commercial alumina support powder comprising 5 wt.-% silica and having a BET surface area of approximately 150 m²/g and a pore volume of about 0.6 cm³/g in an aqueous slurry composition using techniques commonly known in the art. After coating the slurry onto a cordierite substrate followed by drying and calcination at 590 °C, a 1″ diameter by 1.2″ long core was subsequently cut from the monolith to be used as the front zone segment. The Pt to Pd weight ratio was 2:1, and the total Pt and Pd loading was 75 g/ft³ of monolith volume. The BMO-containing rear zone segment was prepared by first combining a commercial zirconia support powder comprising 9 wt.-% La₂O₃ and having a BET surface area of approximately 75 m²/g and a pore volume of about 0.5 cm³/g with solutions of Mn nitrate, Cu nitrate and Ce nitrate in Di water. After milling the resulting mixture to a particle size suitable for coating, boehmite alumina binder was added. The resulting slurry was then coated onto a 1″ diameter by 1.8″ long cordierite substrate which was dried and subsequently calcined at 590 °C for 1 h. The total washcoat loading was 1.8 g/in³ of monolith volume comprising 8.7% by weight Mn, 8.7% by weight Cu, 8.7% by weight Ce, 3% by weight Al₂O₃ binder and balance La₂O₃-stabilized ZrO₂.

### Comparative Example 1B: Preparation of a Catalyst for the Treatment of an Exhaust Gas Stream Containing One or More of Formaldehyde, Nitrogen Oxide (NO), and Hydrocarbons

A catalyst was prepared by coating PGM-containing front zone and BMO-containing rear zone segments separately on 1″ diameter cordierite honeycomb substrates and then combining the coated cores sequentially for subsequent S aging and testing. The process and catalyst compositions are the same as described in Comparative Example 1A, except that no Cu was applied in the rear zone.

### Comparative Example 2: Preparation of a Catalyst for the Treatment of an Exhaust Gas Stream Containing One or More of Formaldehyde, Nitrogen Oxide (NO), and Hydrocarbons

A catalyst was prepared as described in Comparative Example 1A except that the rear zone was not provided with a BMO washcoat layer but rather with a washcoat layer comprising an oxygen storage component (OSC) compound with a composition of 22 wt.-% CeO₂, 68 wt.-% ZrO₂, 5 wt. % La₂O₃, 3 wt.-% Y₂O₃ and 2 wt.-% Nd₂O₃ (OSC-1 compound) as support for 10 wt.-% Mn. The washcoat loading of the rear zone was 3.4 g/in³ of monolith volume.

### Comparative Example 3: Preparation of a Catalyst for the Treatment of an Exhaust Gas Stream Containing One or More of Formaldehyde, Nitrogen Oxide (NO), and Hydrocarbons

A catalyst in accordance with Comparative Example 1A was further processed by adding a topcoat on the base metal oxide (BMO)-containing rear zone, the topcoat having the same commercial zirconia support powder comprising 9 wt.-% La₂O₃, and boehmite alumina binder, to form the catalyst of Comparative Example 3. The topcoat washcoat loading was about 1.1 g/in³ of monolith volume.

### Example 4: Preparation of a Catalyst for the Treatment of an Exhaust Gas Stream Containing One or More of Formaldehyde, Nitrogen Oxide (NO), and Hydrocarbons

A catalyst in accordance with Comparative Example 1B was further processed by adding a topcoat on the base metal oxide (BMO)-containing rear zone, the topcoat being a washcoat consisting of the OSC-1 compound of Comparative Example 2 as support for 10 wt.-% Mn. A boehmite alumina binder was added to form the Inventive Example 4 sample washcoat slurry. The topcoat washcoat loading is about 1.1 g/in³ of monolith volume.

### Example 5: Preparation of a Catalyst for the Treatment of an Exhaust Gas Stream Containing One or More of Formaldehyde, Nitrogen Oxide (NO), and Hydrocarbons

A catalyst in accordance with Comparative Example 1B was further processed by adding a topcoat on the base metal oxide (BMO)-containing rear zone, the topcoat being an oxygen storage component compound comprising a composition of 70 wt.-% CeO₂ and 30 wt.-% ZrO₂ (OSC-2 compound) as support for 10 wt.-% Mn and 10 wt.-% Ce. The topcoat washcoat loading was 1.1 g/in³ of monolith volume being the same as in Example 4.

### Example 6: Preparation of a Catalyst for the Treatment of an Exhaust Gas Stream Containing One or More of Formaldehyde, Nitrogen Oxide (NO), and Hydrocarbons

A catalyst in accordance with Comparative Example 1B was further processed by adding a topcoat on the base metal oxide (BMO)-containing rear zone, the topcoat being a composition of 8 wt.-% CeO₂ and 92 wt.-% Al₂O₃ as support for 10 wt.-% Mn. The topcoat washcoat loading was 1.1 g/in³ of monolith volume, being the same as described in Example 4.

### Example 7: Sulfur Aging and Catalytic Testing

Sulfur aging (S aging) of the catalysts of Comparative Examples 1A, 1B, and 3, as well as of Examples 4, 5 and 6 was accomplished on a lab reactor at 300 °C in a feed comprising 15 ppm SO₂, 150 ppm NO, 10% O₂ and 5 % H₂O. The flow through the catalyst measured as space velocity was 35,000/h. The exposure time was 88 minutes corresponding to a target S exposure amount of 1 g (S)/L of monolith volume. Desulfation was accomplished at 750 °C under isothermal conditions for 30 minutes in a feed comprising 10% O₂ and 5% H₂O. The flow through the catalyst as measured by space velocity was 32,000/h. After sulfation and desulfation, the samples were tested for formaldehyde (HCHO) light-off performance using a feed comprising 180 ppm NO, 1000 ppm CO, 25 ppm HCHO, 100 ppm-C1 from C₂H₄, 190 ppm-C1 from C₁₀H₂₂, 10% O₂, 10% H₂O and 10% CO₂. The flow through the catalyst as measured by space velocity was 50,000/h. The samples were placed in the reactor and first equilibrated at 80 °C in flowing air. The formaldehyde-containing feed was then introduced, and temperature ramping initiated to 300 °C at a ramp rate of 15 °C/min. The formaldehyde concentration was monitored by FTIR during the light-off ramp and conversion performance vs. temperature was subsequently calculated from these measurements.

### Example 8: Engine Aging and Catalytic Testing

Additional sulfur aging (S aging) of the catalysts of Comparative Examples 1B and 2 and Example 4 was accomplished by exposing the catalysts to the exhaust of a diesel engine operating with fuel containing 325 ppm S by weight. 1″×3″ catalyst core samples were loaded into a ceramic monolith holder and placed in the flow of the engine exhaust downstream of a burner DOC used to raise the exhaust temperature for periodic desulfation events. During sulfation, the exhaust temperature at the inlet to the catalyst core samples was maintained at 315 °C, and flow through the catalyst measured as space velocity was 61,000/h. The exposure time at this condition was 180 minutes corresponding to a target S exposure amount of 2 g (S)/L of monolith volume. Desulfation was accomplished by raising the temperature in front of the catalyst core samples to 650 or 700 °C for 30 minutes by injecting diesel fuel in front of the burner DOC upstream of the catalysts. Overall, 5 complete sulfation and desulfation cycles were accomplished with a total S exposure level of 10 g (S)/L of monolith volume. After sulfation and de-sulfation, the samples were tested for HCHO light-off performance as previously described in Example 7.

To further enhance the low temperature HCHO performance after sulfation/de-sulfation at 700 °C, without compromising the HCHO conversion, a two-layer catalyst as described in Example 4 containing an OSC compound was prepared. The results for the catalysts of Comparative Example 1B and Example 4 are shown in FIG. 1. The only difference between the catalyst of Comparative Example 1B and Example 4 was that the catalyst of Example 4 had a topcoat consisting of OSC-1 compound supported with Mn. The formaldehyde conversion performance was higher for Example 4 with an OSC-1 containing topcoat, for both fresh and sulfation/de-sulfation samples, than the reference Comparative Example 1B. At 100 °C, the HCHO conversion is above 40%, even higher than the two-layer catalyst of Comparative Example 3 which has a HCHO conversion about 25% at 100 °C.

Given the results observed for the catalyst comprising the OSC-1 compound, a second OSC-2, with a higher CeO₂-content of 70 wt.-%, was tested. The results for the catalysts of Comparative Example 1B and Example 5 are shown in FIG. 2. The only difference between the catalysts of Comparative Example 1B and Example 5 was that the catalyst of Example 5 had a topcoat consisting of OSC-2 compound supported with Mn. The formaldehyde conversion performance was higher for Example 5 with an OSC-2 containing topcoat, for both fresh and sulfation/de-sulfation samples, than the reference Comparative Example 1B. The results, as shown in FIGS. 1 and 2, indicate that the catalysts comprising OSC-1 and OSC-2, respectively, offer comparable HCHO performance, before and after sulfation/de-sulfation, indicating that Mn on OSC materials can serve as a good S-protective layer, and the amount of Ce loading has no major impact on HCHO performance.

Similar performance for catalysts comprising OSC-1 and OSC-2 in HC conversion (here, the total HC including HCHO) was shown in FIGS. 3 and 4. Both OSC-1 and OSC-2 containing samples show a better performance at high temperature (post light-off)after sulfation/de-sulfation at 700 °C than that of Comparative Example 1B.

Similar observation can also be stated for NO₂/NOx performance for the catalysts of Examples 4 and 5, containing OSC-1 and OSC-2 respectively, in FIGS. 5 and 6.

To further demonstrate the performance of applying an OSC compound, a CeO₂—Al₂O₃ compound was tested. As noted in Example 6, this sample had a Mn on CeO₂—Al₂O₃ support as the topcoat. The only difference between the catalysts of Comparative Example 1B and Example 6 is that the catalyst of Example 6 had a topcoat consisting of a CeO₂—Al₂O₃ compound supported with Mn. The HCHO performance results for the catalysts of Example 6 and Comparative Example 1B are shown in FIG. 7. The formaldehyde conversion performance was higher for Example 6 having a Mn on CeO₂—Al₂O₃ topcoat, than that of the Comparative Example 1B.

However, formaldehyde conversion at low temperature (T<160 °C) was higher for the catalysts of Examples 4 and 5 with an OSC-containing topcoat, than for the catalyst of Example 6, as can be seen from a comparison of the results shown in FIG. 7 and FIGS. 1 and 2.

To further illustrate the advantages of using an OSC compound in the washcoat, in particular in comparison to the materials used in Comparative Example 1B, an OSC-1 containing single layer catalyst, Comparative Example 2, was prepared, as opposed to Comparative Example 1B. The catalysts of Comparative Example 1B and Comparative Example 2 were subjected to a more severe aging, as illustrated in Example 8. The catalyst of Comparative Example 1B had a rear zone comprising 10% Mn and 10% Ce supported on 9 wt.-% La₂O₃-stabilized ZrO₂. The catalyst of Comparative Example 2 had a rear zone comprising 10% Mn supported on an OSC compound with a composition of 22 wt.-% CeO₂, 68 wt.-% ZrO₂, 5 wt.-% La₂O₃, 3 wt.-% Y₂O₃, and 2 wt.-% Nd₂O₃ (OSC-1). The results for this catalyst, compared to that of Comparative Example 1B, on HCHO conversion, are shown in FIG. 8.

As can be seen in FIG. 8, the HCHO conversion is higher for the catalyst of Comparative Example 2 than for that of Comparative Example 1B, in spite of both catalysts containing Ce, Mn and Zr compounds.

The catalyst of Example 4 was also subjected to the same severe engine aging procedure as described in Example 8. The only difference between the catalysts of Comparative Example 1B and Example 4 was that the catalyst of Example 4 had a topcoat consisting of an OSC compound supported with Mn. The results, shown in FIG. 9, indicate again that the catalyst of Example 4 outperforms that of Comparative Example 1B, for low temperature HCHO conversion, despite a lower de-sulfation temperature (650 °C versus 700 °C in FIG. 1) and higher S-exposure (10 g/L versus 1 g/L).

Since both FIGS. 8 and 9 show the HCHO conversion performance after applying five sulfation and 650 °C de-sulfation treatments for the catalysts of Comparative Example 2 and Example 4, respectively in comparison to Comparative Example 1B, said figures allow a comparison of the results for the catalysts of Comparative Example 2 with that of Example 4. It can be seen that the catalyst according to Example 4, thus in accordance with the present invention, performs better at lower temperatures, in particular in the temperature range from 110 to 160 °C, than the catalyst according to Comparative Example 2, which includes an OSC. To ascertain whether a higher de-sulfation temperature is beneficial, the catalyst of Example 4 was further subjected to the same engine aging procedure of Example 8, with the exception that the de-sulfation temperature was raised to 700 °C. The only difference between the catalysts of Comparative Example 1B and Example 4 was that the catalyst of Example 4 had a topcoat consisting of an OSC-1 compound supported with Mn.

The results on HCHO conversion are shown in FIG. 10. As can be seen from FIG. 10, the catalyst of Example 4 shows an improvement with respect to low temperature HCHO performance when a higher desulfation temperature was used, despite a total of 20 g/L of S-exposure.

The above results demonstrate the benefits of using an OSC compound as an enabler for HCHO performance improvement, after sulfation/de-sulfation at 650 or 700 °C, whether it is included in the topcoat or in a single-layer formulation.

### DESCRIPTION OF THE FIGURES

FIG. 1: shows the formaldehyde (HCHO) conversion performance after applying a single sulfation and 700 °C de-sulfation treatment (corresponding to a total S-exposure of about 1 g/L catalyst volume) for the catalysts of Comparative Example 1B and Example 4, respectively.

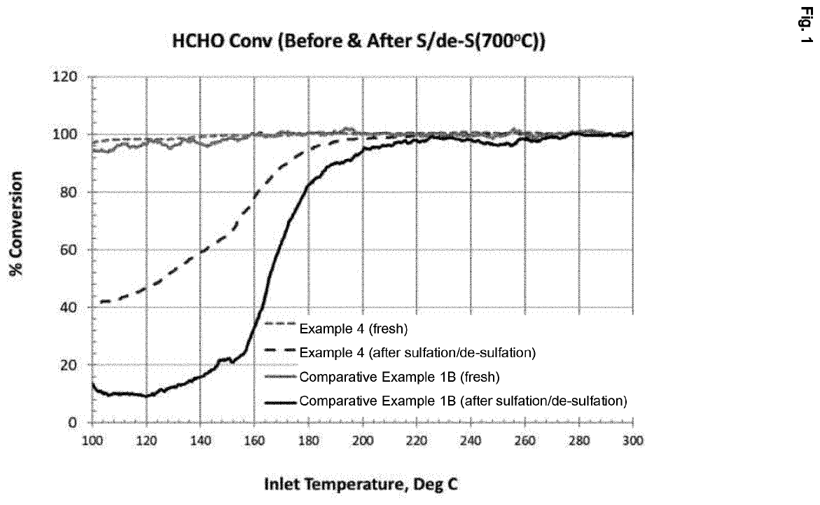

FIG. 2: shows the HCHO conversion performance after applying a single sulfation and 700 °C de-sulfation treatment (corresponding to a total of S-exposure of about 1 g/L catalyst volume) for the catalysts of Comparative Example 1B and Example 5, respectively.

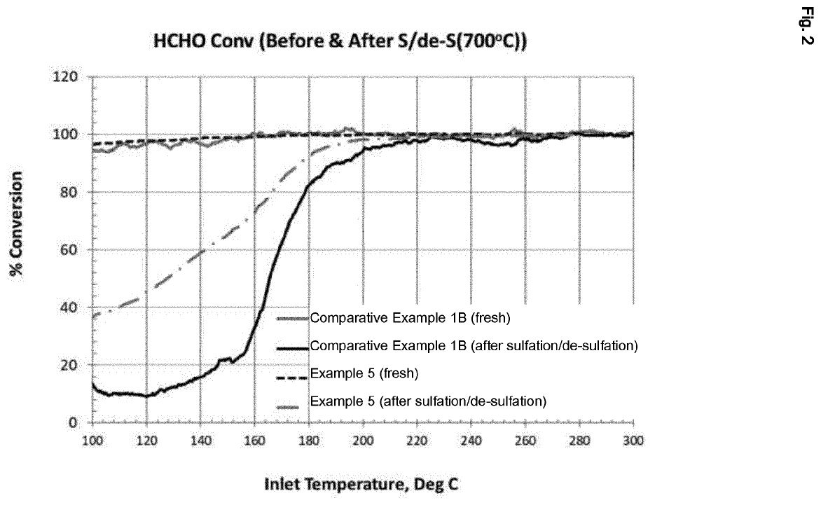

FIG. 3: shows the hydrocarbon (HC) conversion performance before as well as after applying a single sulfation and 700 °C de-sulfation treatment (corresponding to a total S-exposure of about 1 g/L catalyst volume) for the catalysts of Comparative Example 1B and Example 4, respectively.

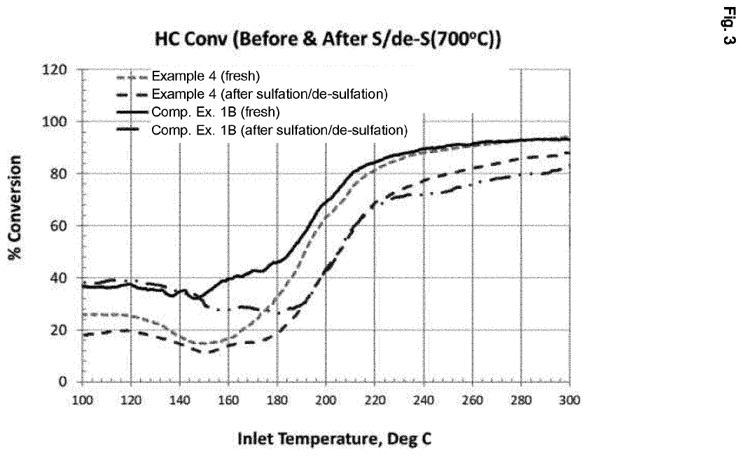

FIG. 4: shows the HC conversion performance before as well as after applying a single sulfation and 700 °C de-sulfation treatment (corresponding to a total S-exposure of about 1 g/L catalyst volume) for the catalysts of Comparative Example 1B and Example 5, respectively.

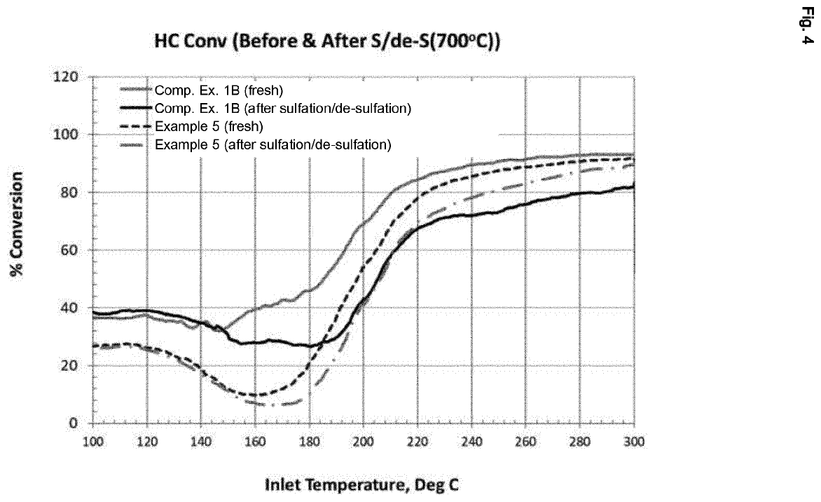

FIG. 5: shows the NO₂/NOx performance before as well as after applying a single sulfation and 700 °C de-sulfation treatment (corresponding to a total S-exposure of about 1 g/L catalyst volume) for the catalysts of Comparative Example 1B and Example 4, respectively.

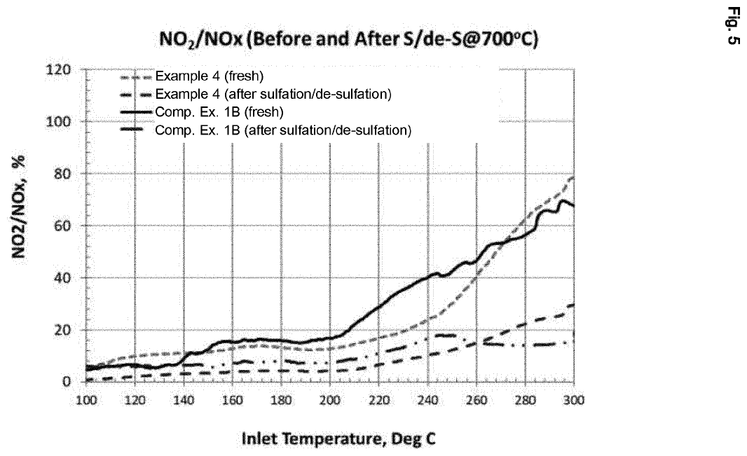

FIG. 6: shows the NO₂/NOx performance before as well as after applying a single sulfation and 700 °C de-sulfation treatment (corresponding to a total S-exposure of about 1 g/L catalyst volume) for the catalysts of Comparative Example 1B and Example 5, respectively.

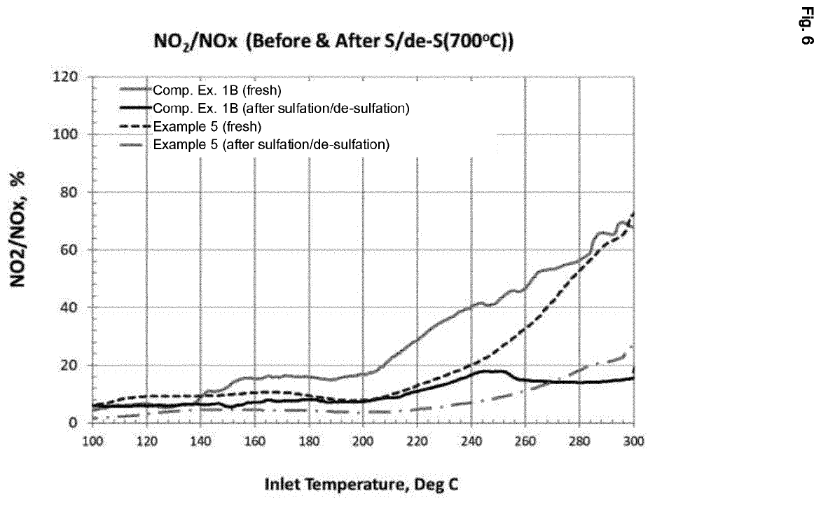

FIG. 7: shows the HCHO conversion performance after applying a single sulfation and 700 °C de-sulfation treatment (corresponding to a total S-exposure of about 1 g/L catalyst volume) for the catalysts of Comparative Example 1B and Example 6, respectively.

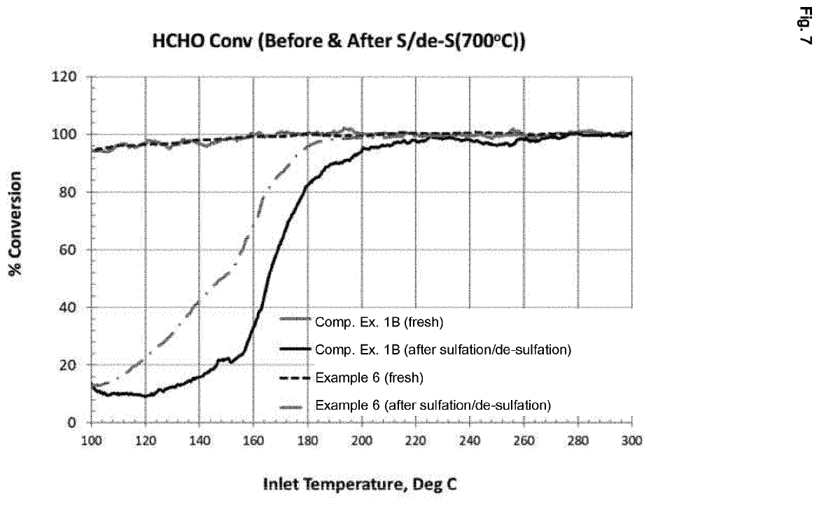

FIG. 8: shows the HCHO conversion performance after applying five sulfation and 650 °C de-sulfation treatments (corresponding to a total S-exposure of about 10 g/L catalyst volume) for the catalysts of Comparative Example 1B and Comparative Example 2, respectively.

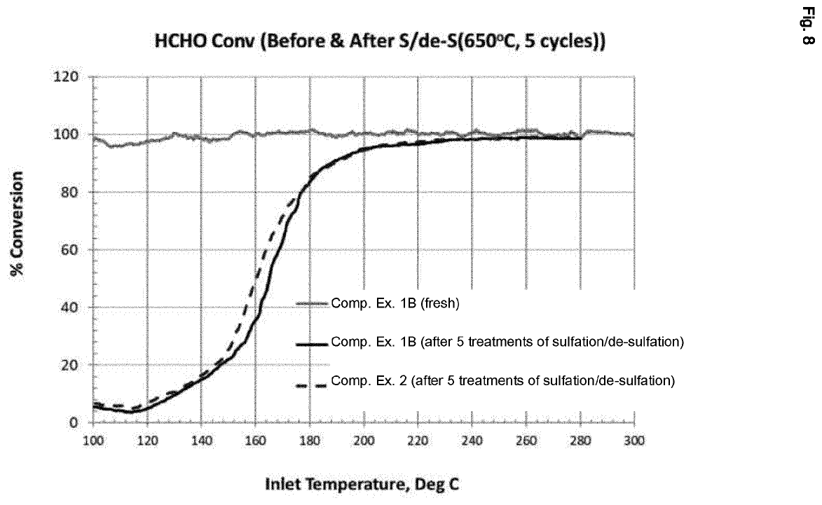

FIG. 9: shows the HCHO conversion performance after applying five sulfation and 650 °C de-sulfation treatments (corresponding to a total S-exposure of about 10 g/L catalyst volume) for the catalysts of Comparative Example 1B and Example 4, respectively.

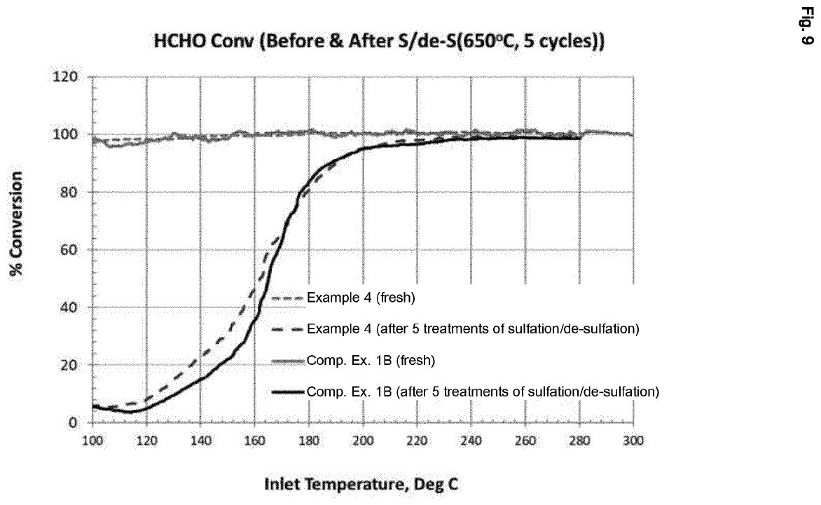

FIG. 10: shows the HCHO conversion performance after applying five sulfation and 650 °C de-sulfation treatments (corresponding to an S-exposure of about 10 g/L catalyst volume) and further aging with five additional sulfation and 700 °C de-sulfation treatments (corresponding to a total S-exposure of about 20 g/L catalyst volume) for the catalyst of Example 4.

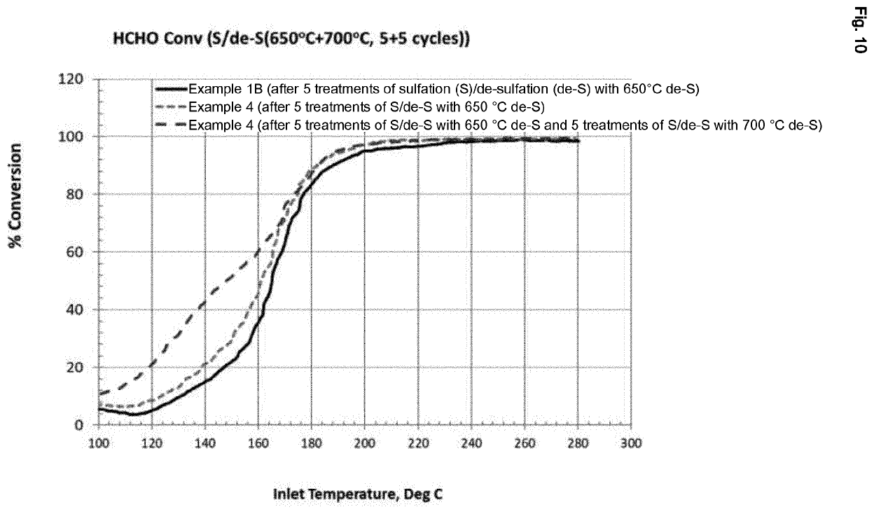

### CITED LITERATURE

WO 2022/047132 A1
U.S. Pat. No. 10,598,061 B2
U.S. Pat. No. 10,392,980 B2
EP 3718627 A1
X. Liu et al. in Journal of Rare Earths 2009, vol. 27, no. 3, p. 418
X. Wu et al. in Journal of Rare Earths 2012, vol. 30, no. 7, p. 659

1. A catalyst for the treatment of an exhaust gas stream containing one or more of formalde-hyde, nitrogen oxide (NO), and hydrocarbons, the catalyst comprising
a first washcoat layer comprising Mn and optionally Ce, wherein Mn and optional Ce are respectively supported on a metal oxide,
a second washcoat layer comprising Mn supported on an oxygen storage compo-nent, wherein the oxygen storage component comprises ceria, and
a substrate,
wherein the substrate has an inlet end through which the exhaust gas stream may enter the catalyst, and an outlet end through which the exhaust gas stream may exit the catalyst,
wherein the catalyst further comprises one or more platinum group metals comprising Pt, Pd, or Pt and Pd, wherein the one or more platinum group metals are at least in part contained in one or more of:
(a) the first washcoat layer,
(b) the second wash coat layer, and
(c) an optional third washcoat layer, or
(d) optional third and fourth washcoat layer.

2. The catalyst of claim 1, wherein the loading of Mn, calculated as the element, in the first washcoat layer is in the range of from 1 to 50 wt.-% based on 100 wt.-% of the first washcoat layer.

3. The catalyst of claim 1, wherein the first washcoat layer comprises Ce, wherein the loading of Ce, calculated as the element, in the first washcoat layer is in the range of from 1 to 50 wt.-% based on 100 wt.-% of the first washcoat layer.

4. The catalyst of claim 1, wherein the loading of Mn, calculated as the element, in the second washcoat layer is in the range of from 0.1 to 50 wt. % based on 100 wt.-% of the second washcoat layer.

5. The catalyst of claim 1, wherein the first washcoat layer comprises Cu.

6. The catalyst of claim 1, wherein the loading of the oxygen storage component in the second washcoat layer is in the range of from 5 to 100 wt.-% based on 100 wt.-% of the second washcoat layer.

7. The catalyst of claim 1, wherein the oxygen storage component comprises ceria and one or more further metal oxides selected from the group consisting of ZrO₂, La₂O₃, Y₂O₃, Nd₂O₃, Pr₂O₃, and Pr₆O₁₁, including mixtures of two or more thereof.

8. The catalyst of claim 1, wherein the catalyst comprises Pt, calculated as the element, at a loading in the range of from 2 to 250 g/ft³.

9. The catalyst of claim 1, wherein the catalyst comprises Pd, calculated as the element, at a loading in the range of from 1 to 80 g/ft³.

10. The catalyst of claim 1, wherein the one or more platinum group metals are supported on a particulate support material.

11. The catalyst of claim 1, wherein the catalyst comprises a third washcoat layer, wherein the one or more platinum group metals are at least in part contained in the third washcoat layer.

12. The catalyst of claim 1, wherein the third washcoat layer comprises a hydrocarbon trap material, wherein the hydrocarbon trap material comprises a molecular sieve.

13. An exhaust gas treatment system comprising an internal combustion engine and an exhaust gas conduit for exhaust gas from the internal combustion engine, wherein the exhaust gas conduit comprises a catalyst according to claim 1.

14. The exhaust gas treatment system of claim 13, wherein the system comprises one or more of an electric heater, a fuel burner, a fuel injector, a selective catalytic reduction (SCR) catalyst, an ammonia oxidation (AMOX) catalyst, a catalyzed soot filter (CSF), a diesel particulate filter (DPF), a selective catalytic reduction catalyst on filter (SCROF), and a diesel exotherm catalyst (DEC).

15. A method for the treatment of an exhaust gas stream containing one or more of formalde-hyde, nitrogen oxide (NO), and hydrocarbons, the method comprising
(A) providing an exhaust gas stream comprising one or more of formaldehyde, nitrogen oxide (NO), and hydrocarbons;
(B) directing the exhaust gas stream provided in (A) through a catalyst according to claim 1.

16. Use of a catalyst according to claim 1, for the oxidation of one or more of formaldehyde, nitrogen oxide (NO), and hydrocarbons.
